(19) United States
(12) Patent Application Publication
(10) Pub. No.: US 2016/0043366 A1
(43) Pub. Date: Feb. 11, 2016

(54) BATTERY PRODUCTION METHOD AND BATTERY MODULE

(71) Applicant: NEC ENERGY DEVICES, LTD., Kanagawa (JP)

(72) Inventor: Toru SUZUKI, Sagamihara-shi (JP)

(73) Assignee: NEC ENERGY DEVICES, LTD., Sagamihara-shi, Kanagawa (JP)

(21) Appl. No.: 14/778,650

(22) PCT Filed: Mar. 18, 2014
(86) PCT No.: PCT/JP2014/057373

§ 371 Date: Sep. 21, 2015

(30) Foreign Application Priority Data
Apr. 19, 2013 (JP) 2013-088071

(51) Int. Cl. H01M 2/10; H01M 10/0525; H01M 10/04; H01M 10/0585; H01M 2/06; H01M 2/02

(52) U.S. Cl. CPC H01M 2/1077; H01M 2/06; H01M 2/0275; H01M 10/0413; H01M 10/0585; H01M 10/0525; H01M 2220/20

(57) ABSTRACT

A battery production method includes: preparing a battery element in which a positive electrode that includes a positive electrode current collector tab, and a negative electrode that includes a negative electrode current collector tab are stacked or wound through a separator; connecting a positive electrode pulled-out tab to the positive electrode current collector tab and connecting a negative electrode pulled-out tab to the negative electrode current collector tab; enclosing the battery element, positive electrode current collector tab and negative electrode current collector tab in a flexible exterior member, with the positive electrode pulled-out tab and negative electrode pulled-out tab being pulled out; forming a reference portion on the exterior member; and boring, in the positive electrode pulled-out tab and negative electrode pulled-out tab being pulled out of the exterior member, holes that are to be used for fixation, based on the reference portion after formation.

### TECHNICAL FIELD

The present invention relates to a method of producing unit cells such as those of a lithium ion secondary battery and to a battery module that includes a plurality of such unit cells.

### BACKGROUND ART

Lithium ion secondary batteries have become popular as power storage devices that are used as power sources of small portable equipment such as mobile phones and digital cameras. In recent years, the batteries are used as power sources of transport means such as electric motorcycles and electric bicycles, or as power sources of housing, commercial facilities, or the like. In this manner, the demand for the batteries has been increasing as large power sources of large capacity and large current.

In particular, a lithium ion secondary battery that employs flexible film as exterior material is gaining attention since the battery is lightweight and highly safe and is suitable for high-density packaging. An assembled battery, or battery module, that employs a plurality of lithium ion secondary batteries using such flexible film as exterior material is used after being stored in a module case that is made of resin or metal or a combination of both.

In this case, screw holes are made in the positive electrode terminals and negative electrode terminals extending from the flexible-film exterior member; the assembled battery and the module case are fixed to each other, with screws inserted into the holes. For example, such a configuration is disclosed by Patent Document 1 (JP2004-339485A).

Incidentally, besides the lithium ion secondary batteries, the power storage elements that are housed in the flexible-film exterior member as described above include electric double layer capacitors and lithium ion capacitors.
[Patent Document 1] JP2004-39485A
[Patent Document 2] JP2003-257408A
[Patent Document 3] WO2006068379
[Patent Document 4] JP2004-63278A

### SUMMARY OF THE INVENTION

### Problems to be Solved by the Invention

According to the invention disclosed in Patent Document 1 (JP2004-39485A), a through-hole that is provided in advance in a terminal of a secondary battery is placed over a screw hole that is provided in advance in an exterior case, and a screw or the like is inserted into the through-hole. In this manner, the secondary battery is fastened and fixed to the module case. If the position of the through-hole is not exactly aligned with the position of the screw hole, a laminate-film exterior member might be deformed when the secondary battery is fixed because the laminate-film exterior member is flexible.

However, if the laminate-film exterior member is deformed when the secondary battery is fixed to the module case, the laminate-film exterior member could be subject to various forces when the module is affected by vibration or shock. The problem is that, in particular, portions of the exterior member from which the positive electrode terminals and negative electrode terminals are pulled out could easily break. Another problem is that a force is also applied to a foil-like current collector tab which is connected to a terminal inside the laminate-film exterior member, and the current collector tab could break.

Incidentally, according to the invention disclosed in Patent Document 2 (JP2003-257408A), in order to strengthen the durability against vibration and shock, the current collector tab and the electrode terminal are connected, or fixed, with screws. However, according to the invention disclosed in Patent Document 2, a hole is made in the foil-like current collector tab, and a screw, which doubles as an electrode terminal, is inserted into the foil-like current collector tab. Therefore, the problem is that the foil-like current collector tab could more easily break.

According to the invention disclosed in Patent Document 3 (WO2006068379), in order to enhance the fixation between battery cells, a hole of a predetermined shape is formed in an electrode terminal. As for batteries that use laminate film as exterior, the position where an electrode terminal is pulled out from a laminate battery, the length of the terminal that is pulled out, and the direction in which the terminal is pulled out, and other positional relations differ from one battery to another. Accordingly, if the hole is formed based on the width and height of an electrode terminal as in the case of the invention disclosed in Patent Document 3, the positional relations of holes could vary between the cells, and, in such a case, the deformation of the laminate-film exterior member is required to fix the cells to each other, raising the possibility that the laminate and the foil-like current collector tab could break. If the size of the hole is made sufficiently larger compared with the diameter of a fastening screw or the like in order to avoid the deformation of the laminate-film exterior member at a time when the holes are aligned with one another, the assembled battery is more likely to move in the module case when shock or vibration is applied. As a result, the deformation of the laminate film is more likely to occur, possibly resulting in the breakage of the laminate film, current collector tab, and electrode terminals.

According to the invention disclosed in Patent Document 4 (JP2004-63278A), in order to increase the sealing performance and heat dissipation of batteries, a portion that lacks an electrode terminal is formed in advance in an area where the electrode terminal overlaps with a laminate-film exterior member, and the components are fixed with screws and pinching members. The invention disclosed in Patent Document 4 does not touch on the fixation of the electrode terminal and module case, and does not pay attention at all to preventing the breakage of the foil-like current collector tab of the assembled battery, and laminate film when shock is applied.

### Means for Solving the Problems

The present invention has been made to solve the above problems. A battery production method of the present invention includes: a preparation step of preparing a battery element in which a positive electrode that includes a positive electrode current collector tab, and a negative electrode that includes a negative electrode current collector tab are stacked or wound through a separator; a connection step of connecting a positive electrode pulled-out tab to the positive electrode current collector tab and connecting a negative electrode pulled-out tab to the negative electrode current collector tab; an enclosing step of enclosing the battery element, positive electrode current collector tab and negative electrode current collector tab in a flexible exterior member, with the positive electrode pulled-out tab and negative electrode pulled-out tab being pulled out; a formation step of forming a reference portion on the exterior member; and a boring step of boring, in the positive electrode pulled-out tab and negative electrode pulled-out tab being pulled out of the exterior member, holes that are to be used for fixation, based on the reference portion after the formation step.

A battery production method of the present invention includes: a preparation step of preparing a battery element in which a positive electrode that includes a positive electrode current collector tab, and a negative electrode that includes a negative electrode current collector tab are stacked or wound through a separator; a connection step of connecting a positive electrode pulled-out tab to the positive electrode current collector tab and connecting a negative electrode pulled-out tab to the negative electrode current collector tab; an enclosing step of enclosing the battery element, positive electrode current collector tab and negative electrode current collector tab in a flexible exterior member, with the positive electrode pulled-out tab and negative electrode pulled-out tab being pulled out; a formation step of forming a reference portion on the exterior member; a connection step of connecting an additional tab member to the positive electrode pulled-out tabor negative electrode pulled-out tab; and a boring step of boring, in the positive electrode pulled-out tab, negative electrode pulled-out tab and additional tab member being pulled out of the exterior member, holes that are to be used for fixation, based on the reference portion after the connection step.

A battery module of the present invention that houses two or more unit cells in a housing body, wherein: the unit cells each include a flexible exterior member that includes a reference portion on a periphery thereof, and a positive electrode pulled-out tab and negative electrode pulled-out tab that are pulled out of the exterior member and where holes are formed; and a first distance between the reference portion and position of a hole formed in the positive electrode pulled-out tab and a second distance between the reference portion and position of a hole formed in the negative electrode pulled-out tab are equal among all the unit cells housed in the housing body.

### Advantages of the Invention

According to the battery production method of the present invention, based on the reference portion of the exterior member, the holes used for fixation are bored in the positive electrode pulled-out tab and negative electrode pulled-out tab. Therefore, according to the battery production method of the present invention, when the unit cells are fixed to a housing body of the battery module or the like, the possibility is low that the unit cells are fixed in such a way as to deform the exterior member. Even if vibration or shock is applied to the battery module, it is possible to reduce the possibility that a portion of the exterior member where pulled-out tabs are pulled out would break, or the possibility that a portion where the pulled-out tabs are connected to foil-like current collector tabs inside the exterior member would break. In this manner, the cells can be produced.

In the battery module of the present invention, the first distance between the reference portion of the exterior member and the position of the hole formed in the positive electrode pulled-out tab, and the second distance between the reference portion of the exterior member and the position of the hole formed in the negative electrode pulled-out tab are equal among all the unit cells housed in the housing body. Therefore, in the battery module of the present invention, the possibility is low that the deformed exterior member would be fixed to the housing body of the battery module or the like. Even if vibration or shock is applied to the battery module, it is possible to reduce the possibility that a portion of the exterior member of the unit cell where pulled-out tabs are pulled out would break, or the possibility that a portion where the pulled-out tabs are connected to foil-like current collector tabs inside the exterior member would break.

### BRIEF DESCRIPTION OF THE DRAWINGS

FIG. 1 is a diagram showing a unit cell 100, which is part of a battery module, and preliminary processing steps thereof.

FIG. 2 is a diagram for explaining a production process of the unit cell.

FIG. 3 is a diagram for explaining a production process of the unit cell.

FIG. 4 is a diagram for explaining a production process of the unit cell.

FIG. 5 is a diagram for explaining a production process of the unit cell.

FIG. 6 is a diagram for explaining a production process of the unit cell.

FIG. 7 is a diagram for explaining a production process of the unit cell.

FIG. 8 is a diagram for explaining a production process of the unit cell.

FIG. 9 is a diagram for explaining a reference portion of the unit cell.

FIG. 10 is a diagram for explaining a boring step of boring a hole, which is used for fixation, in a pulled-out tab.

FIG. 11 is a diagram for explaining a boring step of boring a hole, which is used for fixation, in a pulled-out tab.

FIG. 12 is a diagram for explaining a boring step of boring a hole, which is used for fixation, in a pulled-out tab.

FIG. 13 is a diagram for explaining a unit cell housing body 800 that is used to form a battery module.

FIG. 14 is a diagram for explaining a unit cell housing body 800 that is used to form a battery module.

FIG. 15 is a diagram for explaining how a first connector 828 is mounted on a unit cell housing body 800.

FIG. 16 is a diagram for explaining how a second connector 840 is mounted on a connector mounting panel 847.

FIG. 17 is a diagram for explaining how a connector mounting panel 847 is mounted on a unit cell housing body 800.

FIG. 18 is a front view of a second connector 840 that is mounted on a unit cell housing body 800.

FIG. 19 is a diagram for explaining a production process of a battery module.

FIG. 20 is a diagram for explaining a production process of a battery module.

FIG. 21 is a diagram for explaining a production process of a battery module.

FIG. 22 is a diagram for explaining a production process of a battery module.

FIG. 23 is a diagram for explaining a production process of a battery module.

FIG. 24 is a diagram for explaining a production process of a battery module.

FIG. 25 is a diagram for explaining a production process of a battery module.

FIG. 26 is a diagram for explaining a production process of a battery module.

FIG. 27 is an exploded perspective view of a battery module.

FIG. 28 is a perspective view of a battery module 1000.

FIG. 29 is a diagram for explaining a production process of a battery management circuit unit 1100.

FIG. 30 is a diagram for explaining a production process of a battery management circuit unit 1100.

FIG. 31 is a diagram for explaining a production process of a battery management circuit unit 1100.

FIG. 32 is a diagram showing a battery management circuit unit 1100.

FIG. 33 is a perspective view showing the configuration of a rack member 1200.

FIG. 34 is a diagram showing a rack member 1200 from which a top plate 1220 and a second side plate 1240 have been removed.

FIG. 35 is a front view of a rack member 1200 when seen from direction F in FIG. 33.

FIG. 36 is a diagram for explaining how a battery module 1000 is mounted.

FIG. 37 is a diagram for explaining how an area around a second connector 840 of a battery module 1000 is formed.

FIG. 38 is a diagram showing a power storage device 1300 according to an embodiment of the present invention.

FIG. 39 is a diagram for explaining positional relation between a virtual surface P and a holding plate 1260.

FIG. 40 is a diagram showing a unit cell 100 used in another embodiment and preliminary processing steps thereof.

### BEST MODE FOR CARRYING OUT THE INVENTION

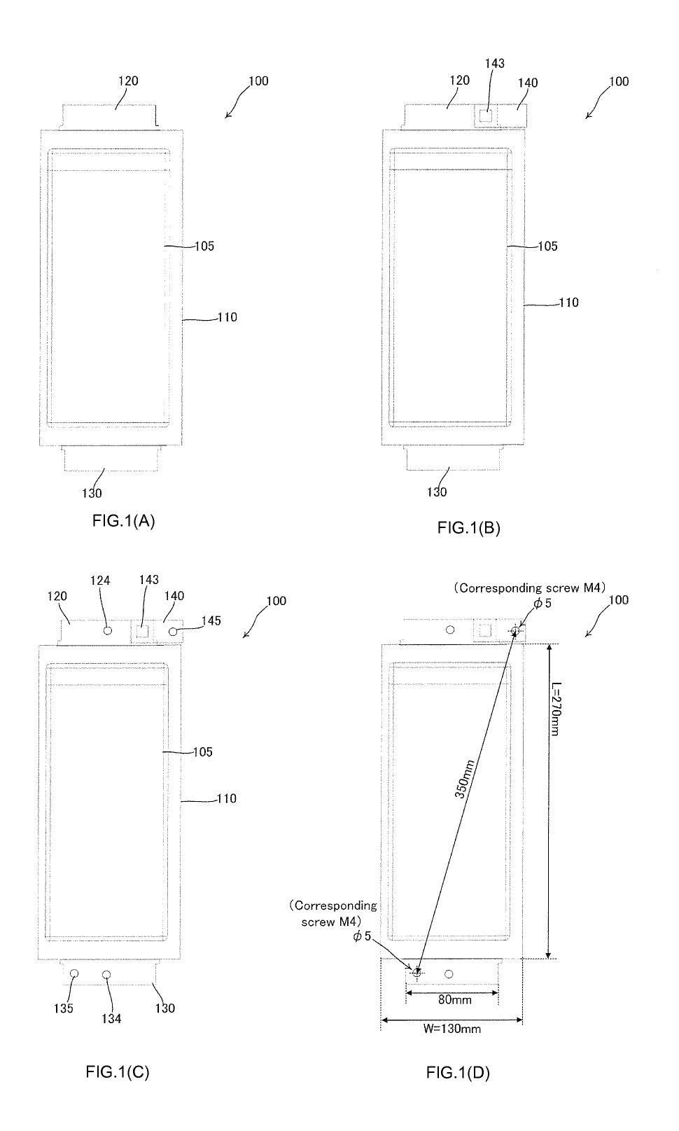

Hereinafter, an embodiment of the present invention will be described with reference to the accompanying drawings. FIG. 1 is a diagram showing a unit cell 100, which is part of a battery module, and preliminary processing steps thereof. As the unit cell 100, a lithium ion secondary unit battery, one type of electrochemical device, is used: charging and discharging take place with lithium ions moving between negative and positive electrodes.

FIG. 1A shows a unit cell 100 which has not yet been subject to preliminary processing. A cell body portion 110 of the unit cell 100 is configured in such a way that an electrode stacked body, in which a plurality of sheet-like positive electrodes and a plurality of sheet-like negative electrodes are stacked via separators, and an electrolysis solution (both of which are not shown in the diagram) are housed in a laminate-film exterior member that is rectangular in planar view. From one end portion (side) of the cell body portion 110, a positive electrode pulled-out tab 120 is pulled out. From the other end portion (side) that faces the one end portion, a negative electrode pulled-out tab 130 is pulled out. A stacking direction, in which the sheet-like positive electrodes and sheet-like negative electrodes are stacked via separators, is defined as a sheet thickness direction.

Both the positive electrode pulled-out tab 120 and the negative electrode pulled-out tab 130 are in a planar shape. Inside the laminate-film exterior member, the tabs are connected directly, or via lead bodies or the like, to positive electrode current collector tabs of the sheet-like positive electrodes and negative electrode current collector tabs of the sheet-like negative electrodes. The laminate-film exterior member is made of metal laminate film having a heat-sealing resin layer. More specifically, for example, two metal laminate films are put together in such a way that the heat-sealing resin layers face each other, thereby forming a laminate-film exterior member; the electrode stacked body that includes the sheet-like positive electrodes, sheet-like negative electrodes, separators, and the electrolysis solution are housed inside the laminate-film exterior member, and the outer periphery of the laminate-film exterior member is thermally sealed. In this manner, the inside of the laminate-film exterior member is sealed.

Metal pieces, such as the positive electrode pulled-out tab 120 and negative electrode pulled-out tab 130 being pulled out of the cell body portion 110 made up of the laminate-film exterior member, are referred to as “pulled-out tabs”. The sheet-like positive electrodes and sheet-like negative electrodes, which are stacked inside the laminate-film exterior member via separators, electrolysis solution or the like, are referred to as “electrodes”.

Incidentally, the electrode stacked body may be: the above-described one in which the sheet-like positive electrodes and sheet-like negative electrodes are stacked via separators; or a stacked body made by stacking sheet-like positive electrodes and sheet-like negative electrodes via separators, and rolling and compressing the stack.

In the case of the above-described unit cell 100, the positive electrode pulled-out tab 120 is generally made of aluminum or aluminum alloy; the negative electrode pulled-out tab 130 is generally made of nickel, or other metal materials plated with nickel (Nickel-plated materials, such as nickel-plated copper, for example), or clads of nickel and other metals (nickel-clad materials, such as nickel-copper clads). According to the present embodiment, the positive electrode pulled-out tab 120 is made of aluminum, and the negative electrode pulled-out tab 130 is made of nickel-plated copper.

For the unit cell 100 having the above-described configuration, preliminary processing is carried out as a step that takes place before the unit cell 100 is placed in a battery module. First, as shown in FIG. 1B, an additional tab member 140, which is made of copper, is fixed to a welding portion 143 by ultrasonic welding. In this manner, the additional tab member 140 is joined to the positive electrode pulled-out tab 120. The reason why the additional tab member 140 is used will be described below.

During the formation of the battery module of the present invention, the positive electrode pulled-out tab 120 of a unit cell 100 and the negative electrode pulled-out tab 130 of a unit cell 100 that is adjacent to that unit cell 100 are mechanically fixed to a copper bus bar with screws. In this manner, the tabs are electrically connected.

In this case, the positive electrode pulled-out tab 120 of the unit cell 100, which contains aluminum, is fixed mechanically to the copper bus bar. According to this configuration, after a predetermined period has passed, the conductivity could deteriorate due to problems of potential difference.

In the battery module of the present invention, as described above, to the positive electrode pulled-out tab 120 of the unit cell 100, the additional tab member 140, which is made of copper, has been joined by welding. The copper additional tab member 140 is then mechanically fixed to the bus bar, thereby resolving the problem of conductivity deterioration resulting from potential difference. According to this configuration, in the mechanical electric connection portion, the electric connection is realized by the same type of metal material. Therefore, there is no problem with potential difference, and the deterioration of conductivity associated with the passage of time is unlikely to occur.

Then, at step shown in FIG. 1C, in the positive electrode pulled-out tab 120, an alignment through-hole 124 is provided; in the additional tab member 140 that is added to the positive electrode pulled-out tab 120, a through-hole 145 is provided; and, in the negative electrode pulled-out tab 130, an alignment through-hole 134 and a through-hole 135 are provided. Of the through-holes, the alignment through-hole 124 of the positive electrode pulled-out tab 120 and the alignment through-hole 134 of the negative electrode pulled-out tab 130 are used for setting the unit cell 100 in the unit cell housing body 800, which will be described in detail later.

On the unit cell housing body 800, unit cell alignment protruding portions 860 are provided. When the unit cell 100 is placed on the unit cell housing body 800, the unit cell alignment protruding portions 860 are inserted into the alignment through-holes 124 and 134. In this manner, the unit cell 100 can be easily set in the unit cell housing body 800, leading to an improvement in production efficiency.

The through-hole 145 of the additional tab member 140 and the through-hole 135 of the negative electrode pulled-out tab 130 are used as described later for: (1) mechanically fixing the unit battery 100 to the unit cell housing body 800; (2) electrically connecting the tabs to the bus bar of the unit cell housing body 800; and (3) electrically connecting the tabs to sense and power lines.

FIG. 1(D) is a diagram for explaining the dimensions of the unit cell 100 that has been preliminarily processed, and the like. The dimensions of the unit cell 100 that is used to make a battery module 1000 of the present embodiment, and the like are shown below:
Dimensions of unit cell 100 (except for pulled-out tabs) : L270 mm, W130 mm
Width of pulled-out tabs: 80 mm
Through-hole 145 of positive electrode-side additional tab member 140: φ5
Through hole 135 of negative electrode pulled-out tab 130: φ5
Distance between through-holes 145 and 135: 350 mm
Screws 889 for through-holes 145 and 135: M4
Weight of unit cell 100: 800 g

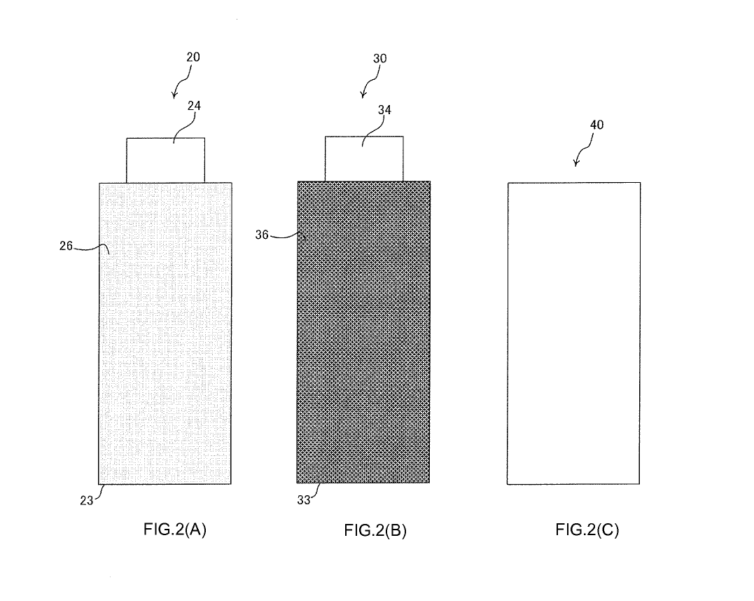

A series of processes from production of the unit cell 100 that is preliminarily processed as described above to a step of boring holes in pulled-out tabs and the like will be described in detail. FIG. 2 is a diagram showing some of a plurality of components prepared for production of the unit cell 100. FIG. 2A shows a positive electrode 20. FIG. 2B shows a negative electrode 30. FIG. 2C shows a separator 40.

As for the positive electrode 20 shown in FIG. 2A, both sides of the positive electrode 20, except for a portion that will become a positive electrode current collector tab 24 on a positive electrode substrate 23 made of aluminum, have a positive electrode material mixture application portion 26 to which a positive electrode material mixture, which is a positive electrode active material such as lithium manganese acid, has been applied.

As for the negative electrode 30 shown in FIG. 2B, both sides of the negative electrode 30, except for a portion that will become a negative electrode current collector tab 34 on a negative electrode substrate 33 made of copper, have a negative electrode material mixture application portion 36 to which a negative electrode material mixture, which is a negative electrode active material such as graphite powder, has been applied.

As for the separator 40 shown in FIG. 2C, sheet-like polyolefin-based material that has fine pores through which lithium ions can pass is used.

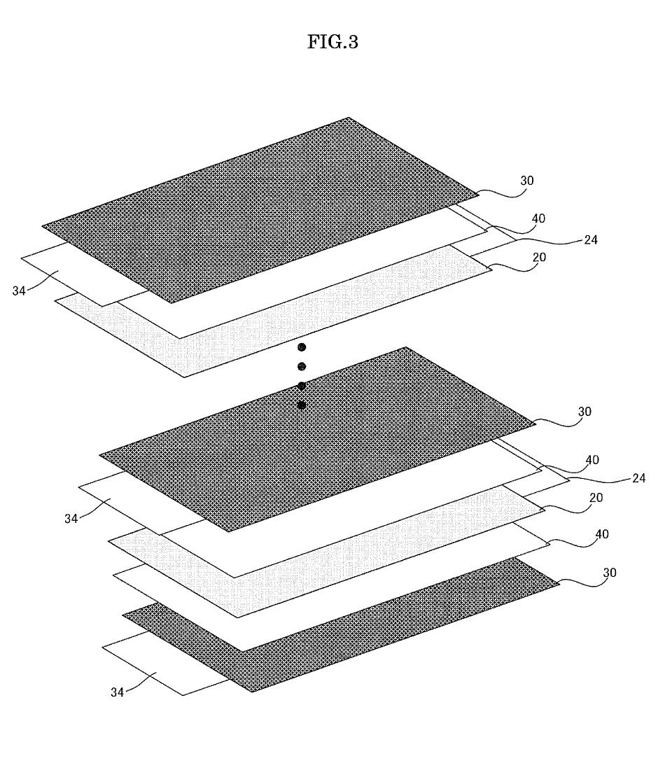

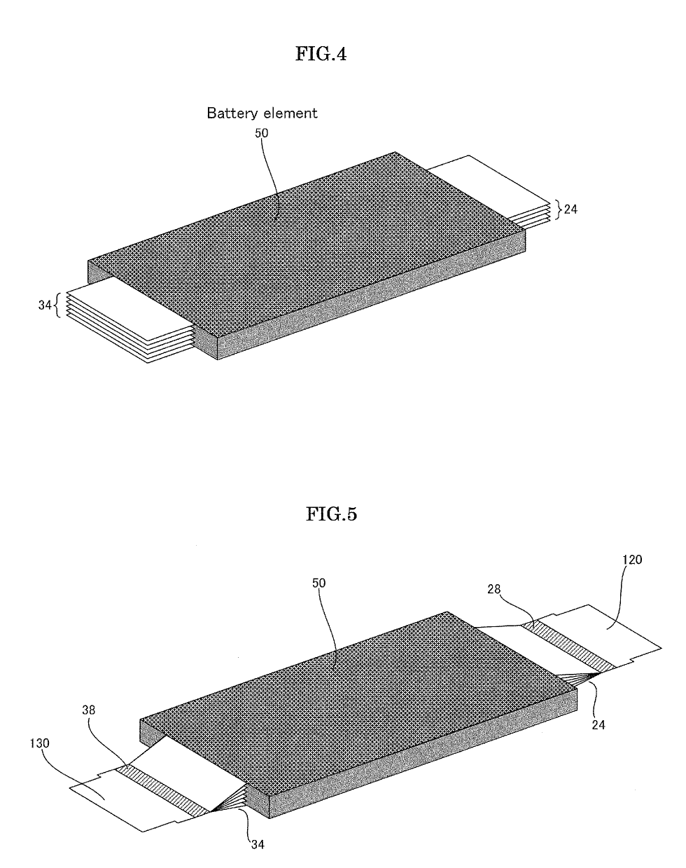

At the step shown in FIG. 3, the above-described materials are, for example, stacked in the following order from bottom: the negative electrode 30, separator 40, positive electrode 20, separator 40, negative electrode 30, . . . , positive electrode 20, separator 40, and negative electrode 30. In the stacked body shown in FIG. 4, which is formed as described above, the negative electrodes 30 always come in the bottom and top portions.

Incidentally, the stacked body in which the positive electrode material mixture application portions 26 of the positive electrodes 20, the negative electrode material mixture application portions 36 of the negative electrode substrates 33, and the separators 40 are stacked will be referred to as a battery element 50 for ease of explanation. That is, from one side of the battery element 50, a plurality of positive electrode current collector tabs 24 extend. From the other side that faces the one side of the battery element 50, a plurality of negative electrode current collector tabs 34 extend.

At the step shown in FIG. 5, in a positive electrode-side connection portion 28, all the positive electrode current collector tabs 24 and an aluminum positive electrode pulled-out tab 120 are connected. In a negative electrode-side connection portion 38, all the negative electrode current collector tabs 34 and a negative electrode pulled-out tab 130, which is made of nickel-plated copper, are connected. Incidentally in the positive electrode-side connection portion 28 and negative electrode-side connection portion 38, an auxiliary conductive member may be used to enhance the connection.

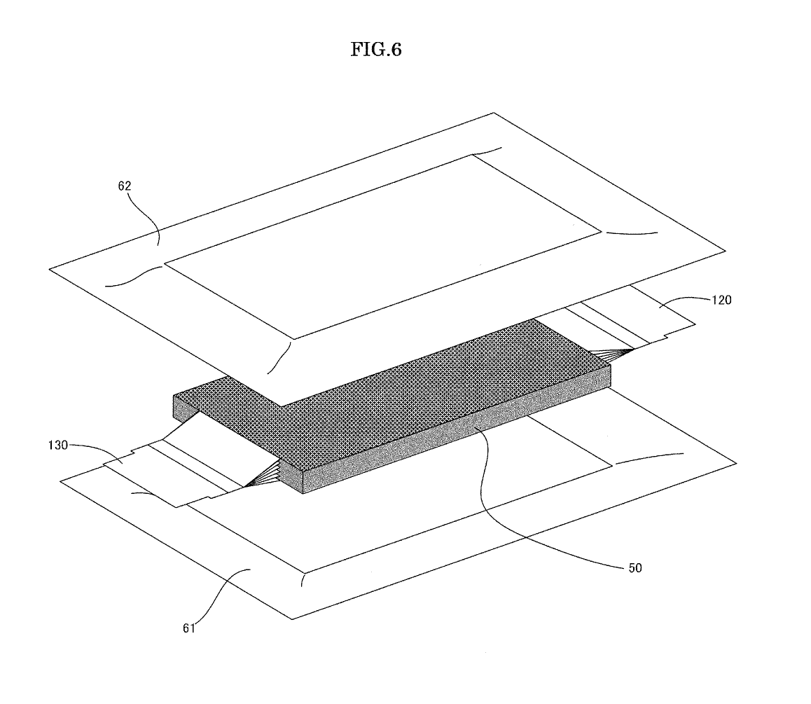

At the step shown in FIG. 6, the battery element 50 is housed by a first laminate film exterior member 61, which has been embossed with a downward convex pattern, and a second laminate film exterior member 62, which has been embossed with an upward convex pattern. At this time, the positive electrode pulled-out tab 120 and negative electrode pulled-out tab 130 are being pulled out of the first laminate film exterior member 61 and second laminate film exterior member 62. As the first laminate film exterior member 61 and second laminate film exterior member 62, sheets that are aluminum foil both sides of which are coated with resin are used.

Incidentally, what is described in the present embodiment is an example in which the battery element 50 is housed in such a way that the battery element 50 is sandwiched between the two laminate film exterior members in the vertical direction. However, the method of housing the battery element 50 by using the laminate film exterior members is not limited to this example. For example, the battery element 50 may be housed by folding one laminate film exterior member. Alternatively, one laminate film exterior member may be turned into a tube with no ends, and the battery element 50 may be housed inside the tube.

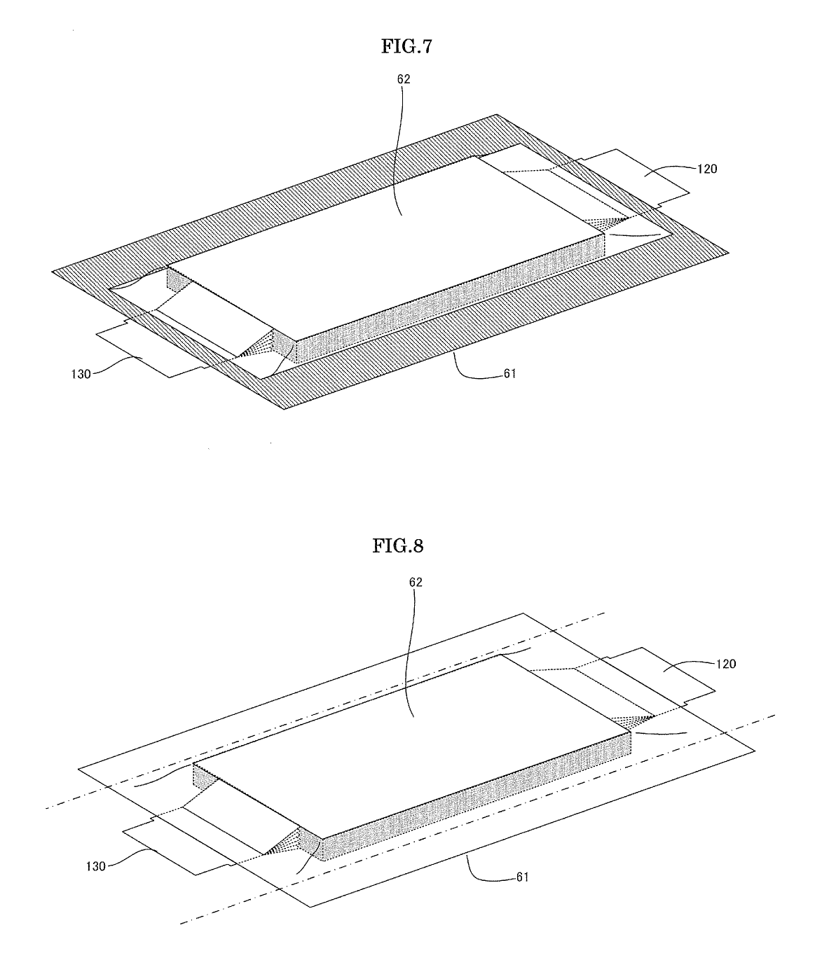

At the step shown in FIG. 7, when the positive electrode pulled-out tab 120 and negative electrode pulled-out tab 130 are being pulled out of the first laminate film exterior member 61 and second laminate film exterior member 62, the peripheries of the laminate film exterior members are thermally sealed except for an opening through which an electrolysis solution will be poured. Then, via the opening, the electrolysis solution (not shown) is poured. The opening is then closed by bonding. In this manner, in the laminate film exterior members, the battery element 50, positive electrode current collector tab 24, negative electrode current collector tab 34, and electrolysis solution (not shown) are enclosed. The shaded region in FIG. 7 represents a region where the laminate film exterior members are bonded together by thermal sealing or adhesives.

FIG. 8 shows a step of cutting off unnecessary portions of the laminate film exterior members after the battery element 50 and the like are enclosed in the laminate film exterior members as described above, or a step of cutting along dashed lines with reference to the positions of the positive electrode pulled-out tab 120 and negative electrode pulled-out tab 130 and the like, for example.

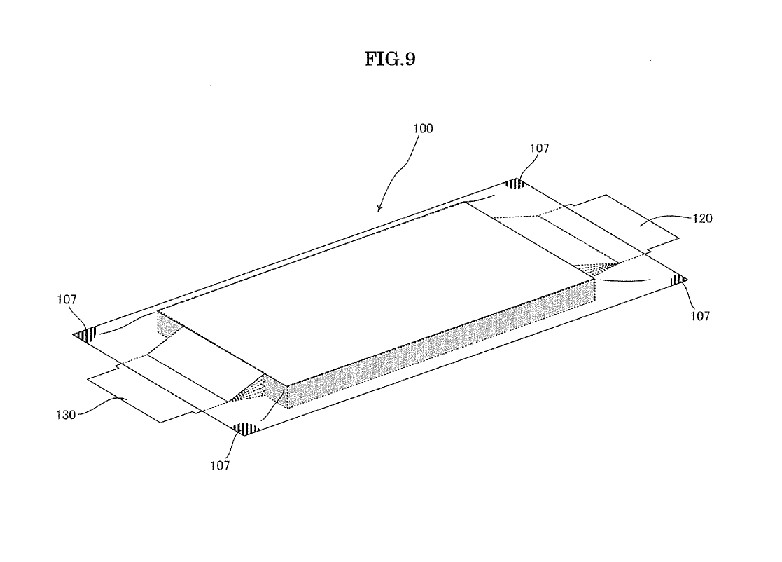

FIG. 9 shows the unit cell 100 that is obtained as a result of the above cutting step. Four corners (shaded areas) on the periphery of the unit battery 100 thus completed function as reference portions 107 at a boring step of boring holes in the pulled-out tabs and the like. The cutting step is also referred to as a reference portion formation step, which is of forming reference portions on the laminate film exterior members.

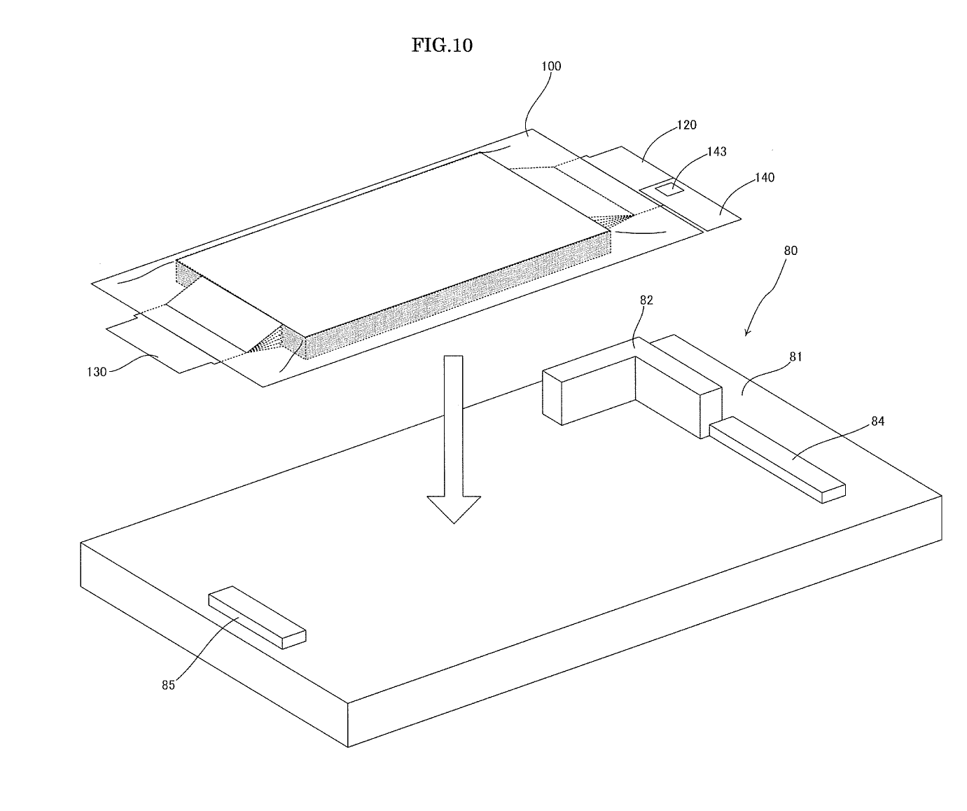

In a jig 80 used for the boring step, as shown in FIG. 10, on a base 81, an alignment reference angle portion 82, which is used to position the unit cell 100, and a positive electrode seat 84 and a negative electrode seat 85, on which the positive electrode pulled-out tab 120 and negative electrode pulled-out tab 130 are placed during the boring step, are provided.

Incidentally, in this example, there is one alignment reference angle portion 82 provided on the jig 80. Instead, there may be more alignment reference angle portions 82 on the jig 80.

FIG. 11 shows the situation where the unit cell 100 is set on the jig 80 at the time of the boring step in such a way that the reference portion 107 of the unit cell 100 is in full contact with the alignment reference angle portion 82 of the jig 80.

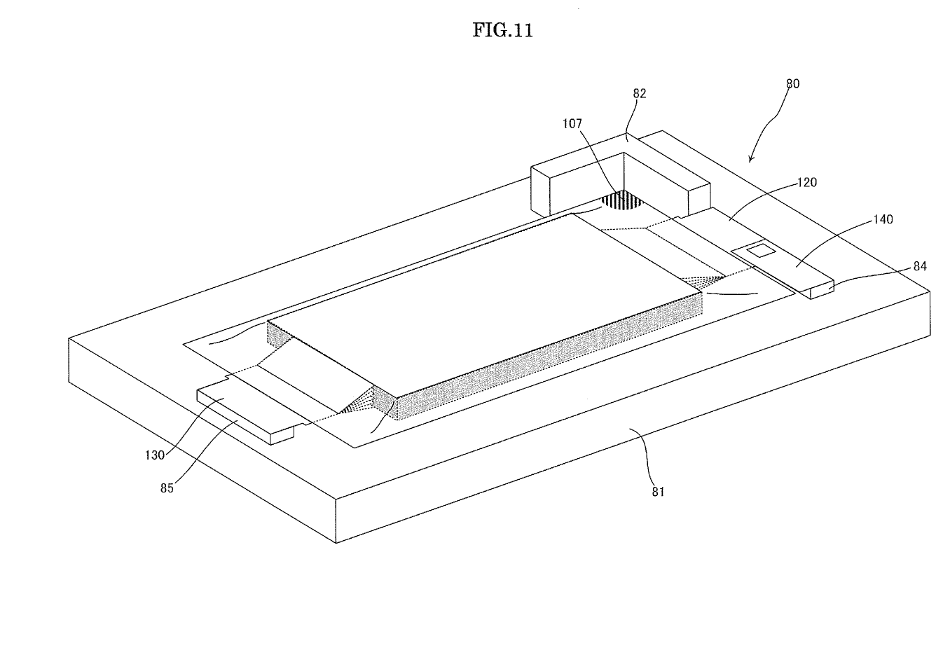

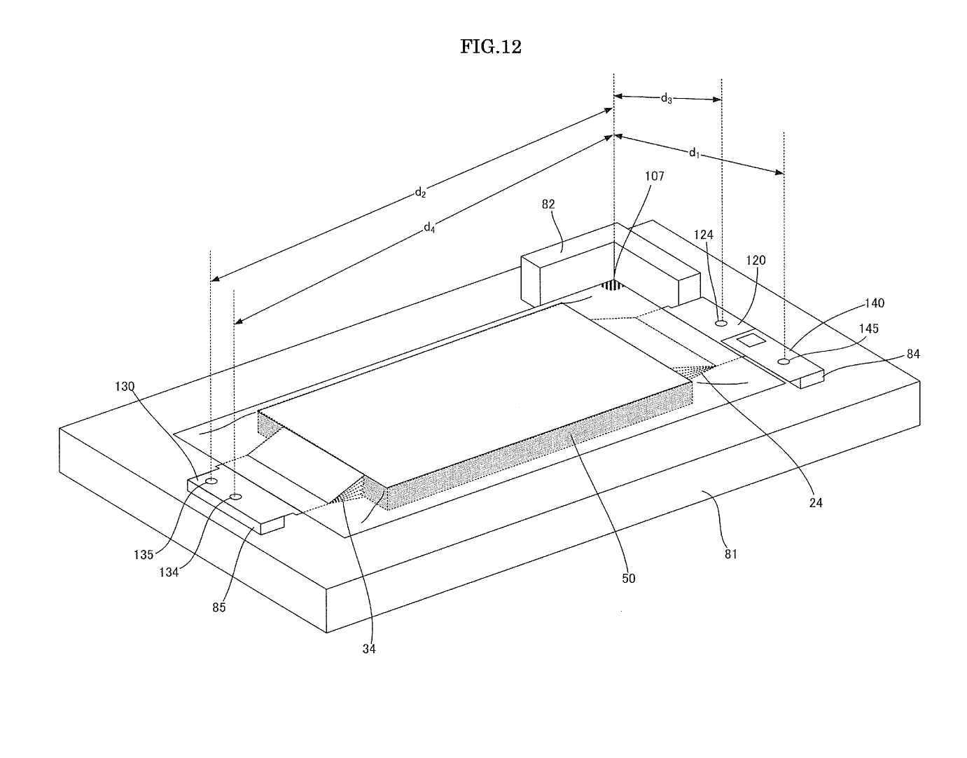

During the boring step shown in FIG. 12, as for the unit cell 100 that has been set as described above, all the through-holes listed below are formed at the same time by a punching machine, not shown, by punching the members: an alignment through-hole 124, which is made in the positive electrode pulled-out tab 120 and is used when the unit cell 100 is placed on a housing body as described later; a through-hole 145, which is made in the additional tab member 140 and is used when the unit cell 100 is fixed to the housing body; an alignment alignment through-hole 134, which is made in the negative electrode pulled-out tab 130 and is used when the unit cell 100 is placed on the housing body; and a through-hole 135, which is used when the unit cell 100 is fixed to the housing body.

Incidentally, in the present example, on the positive-electrode side, a through-hole is provided in the additional tab member 140 so that the through-hole is used when the unit cell 100 is fixed to the housing body. Such a through-hole may be directly provided in the positive electrode pulled-out tab 120.

According to the present embodiment, when holes are bored in the pulled-out tabs of the unit cell 100 and the like, all the holes are simultaneously formed. Instead, the jig 80 may be set on an XY stage or the like, and the holes may be sequentially formed by moving the jig 80 with the XY stage.

As a result of the above-described step, all the distances listed below are equal among any unit cells 100 when a battery module is produced: distance d₁ between the reference portion 107 of the unit cell 100 and the through-hole 145; distance d₂ between the reference portion 107 of the unit cell 100 and the through-hole 135; distance d₃ between the reference portion 107 of the unit cell 100 and the alignment through-hole 1245; and distance d₄ between the reference portion 107 of the unit cell 100 and the alignment through-hole 134.

According to the production method of the unit cell 100 of the present invention, with reference to the reference portion 107 of the laminate film exterior member, holes, which are used for fixation, are bored in the positive electrode pulled-out tab 120 and negative electrode pulled-out tab 130. Therefore, according to the production method of the unit cell of the present invention, when the unit cell 100 is fixed to a battery module housing body or the like, the possibility is low that the laminate film exterior members would deform when the fixation takes place. Even if vibration or shock is applied to the battery module, it is possible to reduce the possibility that a portion of the laminate film exterior member where pulled-out tabs are pulled out would break, or the possibility that a portion where the pulled-out tabs are connected to foil-like current collector tabs inside the exterior members would break. In this manner, the unit cell 100 can be produced.

In the battery module of the present invention, the first distance between the reference portion 107 of the exterior members and the position of the hole formed in the positive electrode pulled-out tab 120, and the second distance between the reference portion 107 of the exterior members and the position of the hole formed in the negative electrode pulled-out tab 130 are equal among all the unit cells 100 housed in the housing body. Therefore, in the battery module of the present invention, the possibility is low that the deformed exterior members would be fixed to the housing body of the battery module or the like. Even if vibration or shock is applied to the battery module, it is possible to reduce the possibility that a portion of the laminate film exterior member of the unit cell 100 where pulled-out tabs are pulled out would break, or the possibility that a portion where the pulled-out tabs are connected to foil-like current collector tabs inside the exterior members would break.

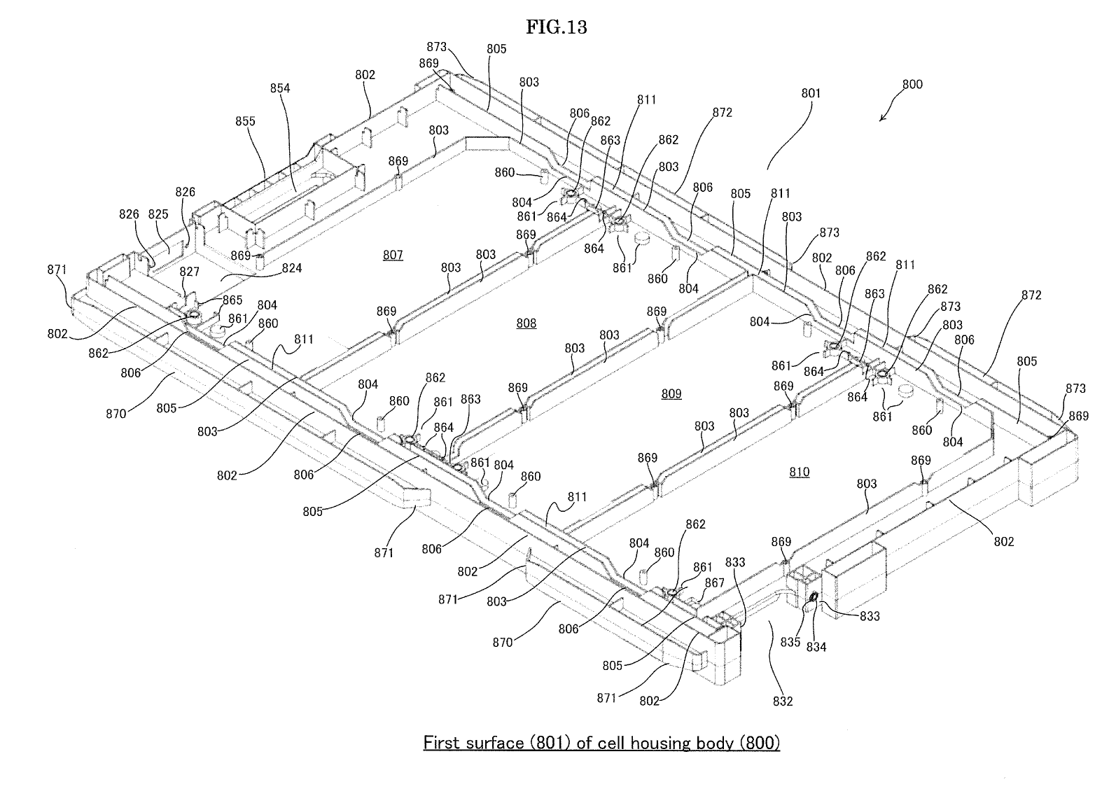

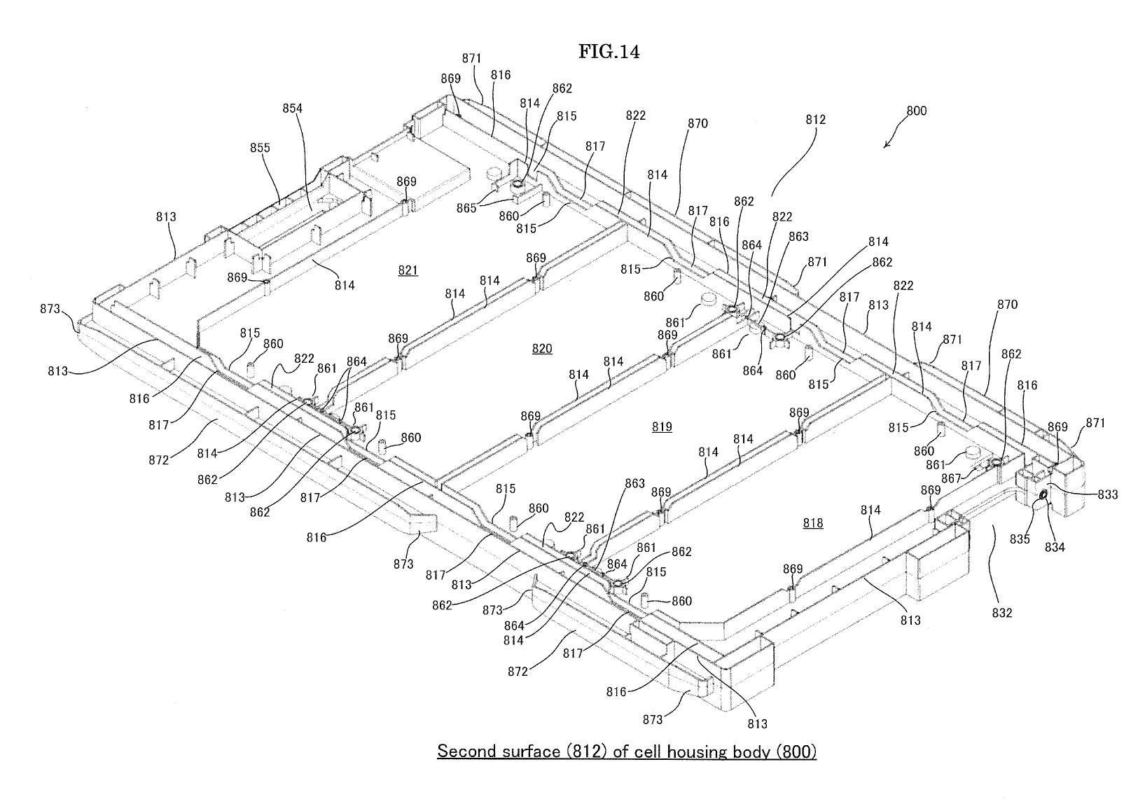

The configuration of the unit cell housing body 800, which houses preliminarily-processed unit cells 100, will be described in detail. FIGS. 13 and 14 are diagrams illustrating the unit cell housing body 800 that is used to form the battery module.

The unit cell housing body 800 is a member that is made of synthetic resin such as ABS. On the unit cell housing body 800, unit cells 100 and the like are mounted; the unit cells 100 and the like are wired.

The unit cell housing body 800 includes a flat-plate substrate, and peripheral partition wall portions, which are formed on the peripheries of the front and back surfaces that are two major surfaces of the substrate. The peripheral partition wall portions include a first surface peripheral partition wall portion, which is provided on the front surface of the substrate, and a second surface peripheral partition wall portion, which is provided on the back surface of the substrate. FIG. 13 is a perspective view of the substrate's front side of the unit cell housing body 800. FIG. 14 is a perspective view of the substrate's back side of the unit cell housing body 800. In the description below, the main surface of the cell housing body on the substrate's front side shown in FIG. 13 is referred to as a first surface 801, and the main surface of the cell housing body on the substrate's back side shown in FIG. 14 is referred to as a second surface 812.

On the first surface 801, the first surface peripheral partition wall portion 802 is provided in such a way as to surround the periphery of the substrate's front surface and to rise in the vertical direction from the substrate's surface. The inside area surrounded by the first surface peripheral partition wall portion 802 is shielded by a cover body, which will be described below.

On the first surface 801, in the inside area surrounded by the first surface peripheral partition wall portion 802, a first surface compartmentalization partition wall portion 803 is provided in such a way as to rise from the surface of the substrate in the vertical direction. The first surface compartmentalization partition wall portion 803 constitutes a partition wall between unit cells 100 that are adjacent to each other within the first surface, and provides an independent housing chamber in which the unit cells 100 are housed. The first surface compartmentalization partition wall portion 803 also functions as a partition wall for a unit cell 100 that is located in an end portion among a row of unit cells 100 disposed. On the first surface 801, the first surface compartmentalization partition wall portion 803 forms a total of four housing spaces for unit cells 100, a first cell housing chamber 807, a second cell housing chamber 808, a third cell housing chamber 809, and a fourth cell housing chamber 810.

On the one-end side of the first surface 801 and on the other end side that faces the one-end side, a first surface intermediate partition wall portion 805 is provided in such a way as to be at a middle point between the first surface peripheral partition wall portion 802 and the first surface compartmentalization partition wall portion 803 and to rise from the surface of the substrate in the vertical direction. The space between the first surface compartmentalization partition wall portion 803 and the first surface intermediate partition wall portion 805 is used as a first surface sense line housing portion 811 in which a sense line, which is used to detect the potential of a tab of a unit cell 100, and the like are laid.

In an area where the direction in which a pulled-out tab of a unit cell 100 is pulled out crosses the first surface compartmentalization partition wall portion 803 at a time when the unit cell 100 is housed in a housing chamber for the unit cell 100 which is formed by the first surface compartmentalization partition wall portion 803, a compartmentalization partition wall cutout portion 804 is provided. Similarly, in an area where the direction in which the pulled-out tab is pulled out crosses the first surface intermediate partition wall portion 805, an intermediate partition wall cutout portion 806 is provided.

As a result of the battery module being used in an abnormal state, abnormalities could occur in one of the unit cells. In such a case, the gas generated inside the laminate film exterior members may be released out of the laminate film exterior members. The compartmentalization partition wall cutout portion 804 and the intermediate partition wall cutout portion 806 function as an exhaust structure for releasing the above gas. Therefore, it is possible to reduce the effects of the gas on adjacent unit cells.

On the second surface 812, the second surface peripheral partition wall portion 813 is provided in such a way as to surround the periphery of the substrate's back surface and to rise in the vertical direction from the substrate's back surface. The inside area surrounded by the second surface peripheral partition wall portion 813 is shielded by a cover body, which will be described later.

On the second surface 812, in the inside area surrounded by the second surface peripheral partition wall portion 813, a second surface compartmentalization partition wall portion 814 is provided in such a way as to rise from the surface of the substrate in the vertical direction. The second surface compartmentalization partition wall portion 814 constitutes a partition wall between unit cells 100 that are adjacent to each other within the second surface, and provides an independent housing chamber in which the unit cells 100 are housed. The second surface compartmentalization partition wall portion 814 also functions as a partition wall for a unit cell 100 that is located in an end portion among a row of unit cells 100 disposed. On the second surface 812, the second surface compartmentalization partition wall portion 814 forms a total of four housing spaces for unit cells 100, a fifth cell housing chamber 818, a sixth cell housing chamber 819, a seventh cell housing chamber 820, and an eighth cell housing chamber 821. In the unit cell housing body 800, a total of eight unit cells 100 are housed both on the first surface 801 and the second surface 812.

On the one-end side of the second surface 812 and on the other end side that faces the one-end side, a second surface intermediate partition wall portion 816 is provided in such a way as to be at a middle point between the second surface peripheral partition wall portion 813 and the second surface compartmentalization partition wall portion 814 and to rise from the surface of the substrate in the vertical direction. The space between the second surface compartmentalization partition wall portion 814 and the second surface intermediate partition wall portion 816 is used as a second surface sense line housing portion 822 in which a sense line, which is used to detect the potential of a tab of a unit cell 100, and the like are laid.

In an area where the direction in which a pulled-out tab of a unit cell 100 is pulled out crosses the second surface compartmentalization partition wall portion 814 at a time when the unit cell 100 is housed in a housing chamber for the unit cell 100 which is formed by the second surface compartmentalization partition wall portion 814, a compartmentalization partition wall cutout portion 815 is provided. Similarly, in an area where the direction in which the pulled-out tab is pulled out crosses the second surface intermediate partition wall portion 816, an intermediate partition wall cutout portion 817 is provided.

As a result of the battery module being used in an abnormal state, abnormalities could occur in one of the unit cells. In such a case, the gas generated inside the laminate film exterior members may be released out of the laminate film exterior members. The compartmentalization partition wall cutout portion 815 and the intermediate partition wall cutout portion 817 function as an exhaust structure for releasing the above gas. Therefore, it is possible to reduce the effects of the gas on adjacent unit cells.

As described above, the unit cell housing body 800 includes, on the first surface 801, the four housing chambers for unit cells 100, i.e. the first cell housing chamber 807, the second cell housing chamber 808, the third cell housing chamber 809, and the fourth cell housing chamber 810. The unit cell housing body 800 includes, on the second surface 812, the four housing chambers for unit cells 100, i.e. the fifth cell housing chamber 818, the sixth cell housing chamber 819, the seventh cell housing chamber 820, and the eighth cell housing chamber 821. The unit cell housing body 800 includes a total of eight housing chambers for unit cells 100 on both the surfaces. If one cell housing chamber houses one unit cell 100, the unit cell housing body 800 of the present embodiment can house up to eight unit cells 100. Incidentally, in the battery module of the present invention, the number of unit cells 100 that can be housed by the unit cell housing body 800 is not limited to this example. Any number of unit cells 100 can be housed by the unit cell housing body 800 as long as both sides of the unit cell housing body 800 are utilized.

In one end portion of the unit cell housing body 800 (or an end portion of the side where the first cell housing chamber 807 and the eighth cell housing chamber 821 are disposed), a first connector housing concave portion 824 is provided as a space where a first connector 828 is to be disposed in order to take out power from the unit cells 100 connected in series.

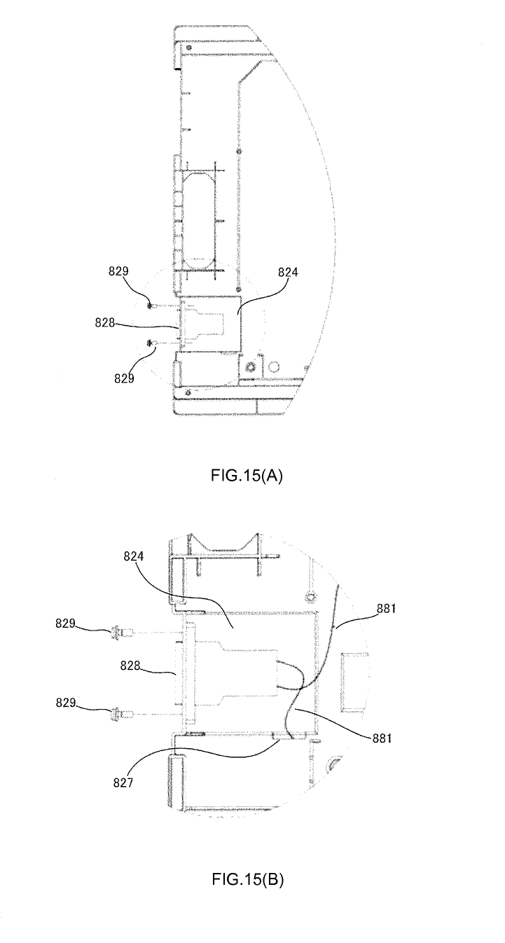

FIG. 15 is a diagram for explaining how the first connector 828 is mounted on the unit cell housing body 800. FIG. 15B is an enlarged view of major parts of FIG. 15A. On a sidewall of the unit cell housing body 800, a first connector mounting opening portion 825, which is used to mount the first connector 828, and first connector mounting screw holes 826, which are located on both sides of the first connector mounting opening portion 825, are provided. The first connector 828 is fitted into the first connector mounting opening portion 825, and mounting screws 829 are screwed into the first connector mounting screw holes 826. As a result, the first connector 828 is secured to the unit cell housing body 800. In the vicinity of the first connector housing concave portion 824, a power line opening portion 827 is provided in such a way as to pass through the first surface 801 and second surface 812, allowing a power line 881 of the first connector 828, which is provided on the first surface 801's side, to extend to the second surface 812's side.

In one end portion of the unit cell housing body 800 (or an end portion of the side where the fourth cell housing chamber 810 and the fifth cell housing chamber 818 are disposed), a second connector mounting concave portion 832 is provided as a space where a second connector 840 is disposed in order to take out output from a sense line extending from a unit cell 100 and output from a thermistor connection line.

From the second connector 234, information about the potential of a tab of each of the unit cells 100 connected in series, and information about temperatures inside the module can be retrieved. Based on the information about the potential of a tab of each of the unit cells 100, a battery management circuit unit 1100, described later, is able to manage each unit cell 100.

When the battery module 1000 is mounted on a power storage device 1200, the battery module 1000 is fitted into a connector (seventh connector 1152, described later) located in a back portion of a housing of the power storage device 1200, while the position of the battery module 1000 is restricted by a rail member. At this time, if there is tolerance on the rail member or the like, it could be difficult to connect the second connector 840 and the seventh connector 1152. The second connector 840 is formed in such a way as to be slightly adjustable to cover the above tolerance.

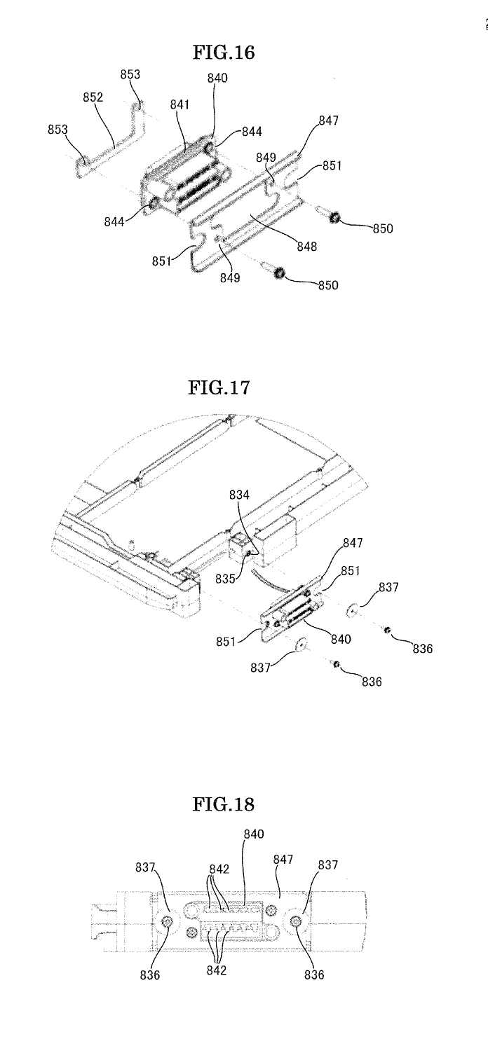

The second connector 840 will be described based on FIGS. 16 to 18. FIG. 16 is a diagram for explaining how the second connector 840 is mounted on a connector mounting panel 847. FIG. 17 is a diagram for explaining how the connector mounting panel 847 is mounted on the unit cell housing body 800. FIG. 18 is a front view of the second connector 840 that is mounted on the unit cell housing body 800.

On both ends of a body portion 841 of the second connector 840, two through-holes 843 (not shown in FIG. 16) are provided. Bushes 844 are mounted in the two through-holes 843. The outer diameter of the bushes 844 is an amount of 2Δb smaller than the inner diameter of the through-holes 843. Therefore, the body portion 841 of the second connector 840 can move within the range of 2Δb with respect to the bushes 844.

The second connector 840 is fitted into a connector mounting opening portion 848 of the connector mounting panel 847. The second connector 840 is secured to the connector mounting panel 847 with mounting screws 850, which are inserted or screwed into a connector mounting screw hole 849 of the connector mounting panel 847, bushes 844, female screw holes 853 of a fastening member 852. Accordingly, the second connector 840 can move within the range of 2Δb with respect to the connector mounting panel 847.

In a panel mounting base portion 833 of the second connector mounting concave portion 832, a screw hole peripheral protruding portion 835 is provided in such a way as to protrude from a plane where the panel mounting base portion 833 has been formed. At the center of the screw hole peripheral protruding portion 835, a panel mounting screw hole 834 is provided to be used for mounting of the connector mounting panel 847 on the unit cell housing body 800.

The outer diameter of the screw hole peripheral protruding portions 835 that are inserted into mounting cutout portions 851 provided on both sides of the connector mounting panel 847 is an amount of 2Δa smaller than the inner-side portions of the mounting cutout portions 851. The connector mounting panel 847 can move within the range of 2Δa with respect to the unit cell housing body 800.

The connector mounting panel 847 to which the second connector 840 has been attached is mounted on the unit cell housing body 800 with mounting screws 836, which are inserted into connector mounting screw holes 849, retaining washers 837, mounting cutout portions 851, and panel mounting screw holes 834.

The connector mounting panel 847 can move within the range of 2Δa with respect to the unit battery housing body 800. Furthermore, the second connector 840 can move within the range of 2Δb with respect to the connector mounting panel 847. Therefore, the second connector 840 can move within the range of 2Δa+2Δb with respect to the unit cell housing body 800. The dimensional relation Δa>Δb is set. Therefore, the second connector 840 of the battery module 1000, which is guided while being positionally restricted by the rail member, can be more smoothly fitted into the seventh connector 1152.

In the end portion of the unit cell housing body 800 (or the end portion of the side where the first cell housing chamber 807 and the eighth cell housing chamber 821 are disposed), a handle through-hole 854 is provided in such a way as to pass through the area between the first surface 801 and the second surface 812. The handle through-hole 854 and the surrounding area thereof function as a handle portion 855. The handle portion 855 is aimed at improving the handling of the battery module.

Between the fourth cell housing chamber 810 of the first surface 801 of the unit cell housing body 800 and the fifth cell housing chamber 818 of the second surface 812, a bus bar guidance through-hole 867 is provided in such a way as to pass through the area between the first surface 801 and the second surface 812.

In the battery module of the present invention, the cells that are disposed in each of the cell housing chambers are connected in series. The bus bar guidance through-hole 867 allows a surface-to-surface bus bar 877 to straddle the fourth cell housing chamber 810 of the first surface 801 and the fifth cell housing chamber 818 of the second surface 812. Therefore, the unit cell 100 housed in the fourth cell housing chamber 810 can be electrically connected to the unit cell 100 housed in the fifth cell housing chamber 818 via the surface-to-surface bus bar 877.

In each of the first to eighth cell housing chambers 807 to 821, two unit cell alignment protruding portions 860 are provided in such a way as to rise from the front or back surface of the substrate.

One unit cell alignment protruding portion 860 of each housing chamber is fitted into an alignment through-hole 124 of the positive electrode pulled-out tab 120, and the other unit cell alignment protruding portion 860 is fitted into the alignment through-hole 134 of the negative electrode pulled-out tab 130. This configuration allows the unit cells 100 to be quickly positioned and set in the unit cell housing body 800, and is therefore effective in terms of production efficiency.

In each housing chamber, tab member placement portions 861 are provided in such a way as to rise from the plane of the front or back surface of the substrate. The tab member placement portions 861 are formed in such a way as to keep the following parts a predetermined distance away from the plane when the unit cells 100 are set on the unit cell housing body 800: the positive electrode pulled-out tabs 120 and negative electrode pulled-out tabs 130 of the unit cells 100, and bus bars that are disposed between the tabs.

In a part of the tab member placement portions 861, tab member fixing screw holes 862 are provided. Screws are screwed into the tab member fixing screw holes 862 in order to: (1) mechanically fix the unit cells 100 to the unit cell housing body 800; (2) electrically connect the tabs to the bus bars of the unit cell housing body 800; and (3) electrically connect the tabs to sense and power lines. The tab member fixing screw holes 862 are preferably metal cylindrical bodies in which a screw pattern is formed; the cylindrical bodies are embedded in the unit cell housing body 800, which is made of resin, by integral molding.

In some of the tab member fixing screw holes 862 of the tab member placement portions 861, a cross-shaped rib structure is provided to reinforce the tab member fixing screw holes 862. In some of the tab member fixing screw holes 862 where an inter-tab member bus bar 876 is provided, an inter-screw hole bridge portion 863 is provided between the adjacent tab member fixing screw holes 862, allowing the inter-tab member bus bar 876 to be placed in a stable manner. Furthermore, on the upper surface of the inter-screw hole bridge portion 863, a bus bar alignment protruding portion 864 is provided. The bus bar alignment protruding portion 864 is fitted into a through-hole that is provided in advance in the inter-tab member bus bar 876. In this manner, the inter-tab member bus bar 876 can be easily set, leading to an improvement in the production efficiency.

The positive electrode pulled-out tab 120 of the unit cell 100 housed in the first cell housing chamber 807 of the first surface 801, and the negative electrode pulled-out tab 130 of the unit cell 100 housed in the eighth cell housing chamber 821 of the second surface 812 are connected not only to the sense line but also to the power line. In order to fix an end portion bus bar 875 which is used for the above purpose, an end portion bus bar fixing frame 865 is provided in each housing chamber.

In one end portion of the outer periphery of the unit cell housing body 800, a first end side protruding guide member 870 is provided. On the other end portion that faces the above end portion, a second end side protruding guide member 872 is provided. The first end side protruding guide member 870 and the second end side protruding guide member 872 are formed in such a way as to have a convex portion that seamlessly extends in the longitudinal direction. The convex portion slides along a concave guide member 1145 of the rail member, which will be described below. Therefore, it is possible to place the battery module 1000 of the present invention in the housing of the power storage device 1200.

In both end portions of the first end side protruding guide member 870, tapered portions 871 are provided. In both end portions of the second end side protruding guide member 872, tapered portions 873 are provided. Accordingly, when the battery module 100 is inserted into the concave guide member 1145 of the rail member as described above, the above configuration makes the insertion easier and helps improve the handling of the battery module 1000. When the battery module 100 is removed from the concave guide member 1145 of the rail member, the tapered portions have play. Therefore, this configuration reduces the need for a user to pay attention to the direction in which the battery module 1000 is removed, and helps improve the handling of the battery module 1000.

The width of the first end side protruding guide member 870 is different from the width of the second end side protruding guide member 872. This prevents the battery module 1000 from being removed from or inserted into the power storage device 1200 in an unexpected posture. Incidentally, the width of the first end side protruding guide member 870 or the width of the second end side protruding guide member 872 can be defined as the length that is seen in a direction perpendicular to the front or back surface of the substrate.

The first end side protruding guide member 870 and the second end side protruding guide member 872 are side surfaces that are different from the front and back surfaces of the substrate. The first end side protruding guide member 870 and the second end side protruding guide member 872 are provided on two opposing side surfaces in such a way as to extend along the planar direction of the front or back surface of the substrate.

The first end side protruding guide member 870 and the second end side protruding guide member 872 are provided in such a way as to protrude from the peripheral partition wall portions (802, 813) or to extend from the substrate. It can be said that the amount of protrusion or extension from each of the tapered portions varies.

The unit cell housing body 800 employs the structure in which the unit cells 100 and various wires disposed on the first surface 801 are shielded with a first surface cover body 910, and the unit cells 100 and various wires disposed on the second surface 812 are shielded with a second surface cover body 920.

Accordingly, 16 cover body fixing screw holes 869, which are used when the first surface cover body 910 is screwed to the first surface 801, are provided on the first surface 801. Similarly, 16 cover body fixing screw holes 869, which are used when the second surface cover body 920 is screwed to the first surface 220, are provided on the second surface 812. On each surface, 16 cover body fixing screw holes 869 are provided. However, all the cover body fixing screw holes 869 may not be used for the screwing. Moreover, the number of cover body fixing screw holes 869 provided on one surface is not limited to 16; any number of cover body fixing screw holes 869 can be provided.

A process of making the battery module of the present invention by mounting such components as unit cells 100 on the unit cell housing body 800 having the above-described configuration will be described.

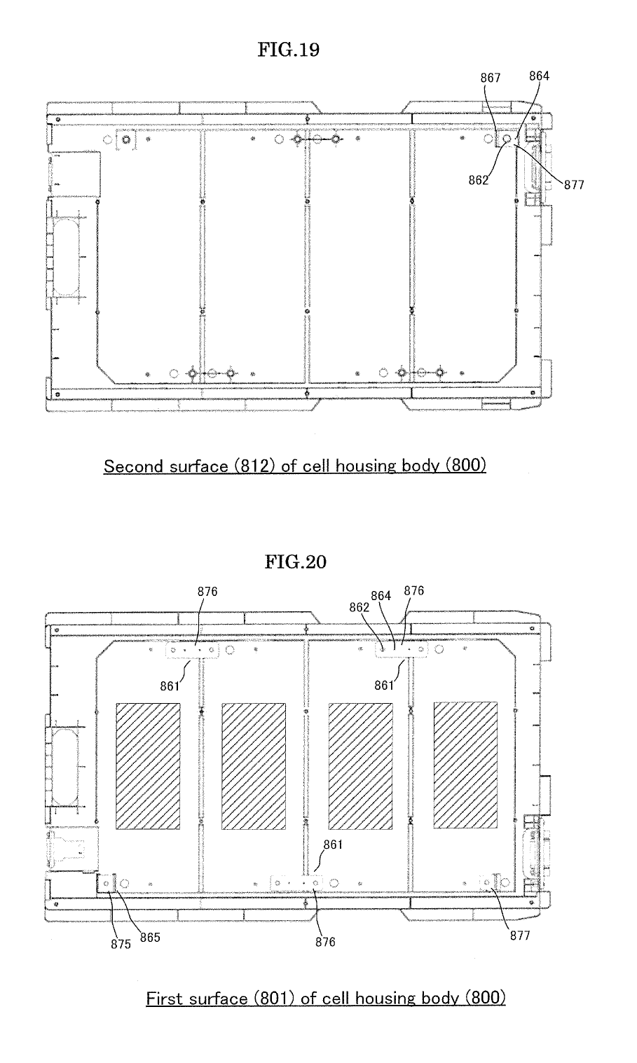

At the step shown in FIG. 19, a surface-to-surface bus bar 877 is set: the surface-to-surface bus bar 877 is used to electrically connect a unit cell 100 housed in the fourth cell housing chamber 810 of the first surface 801 and a unit cell 100 housed in a fifth cell housing chamber 818 of the second surface 812. The surface-to-surface bus bar 877 is inserted into the bus bar guidance through-hole 867, and the through-hole provided in the surface-to-surface bus bar 877 is fitted onto the bus bar alignment protruding portion 864. In this manner, the surface-to-surface bus bar 877 has been mounted. In the surface-to-surface bus bar 877, a through-hole corresponding to the tab member fixing screw hole 862 is also provided in advance.

At the step shown in FIG. 20, the through-hole provided in the inter-tab member bus bar 876 is fitted onto the bus bar alignment protruding portion 864. In this manner, the inter-tab member bus bar 876 is set on the tab member placement portion 861. In the inter-tab member bus bar 876, a through-hole corresponding to the tab member fixing screw hole 862 is also provided in advance. At this step, on the end portion bus bar fixing frame 865, the end portion bus bar 875 is set. In the end portion bus bar 875, a through-hole corresponding to the tab member fixing screw hole 861 is provided in advance. Moreover, an adhesive is applied to the shaded area of each cell housing chamber.

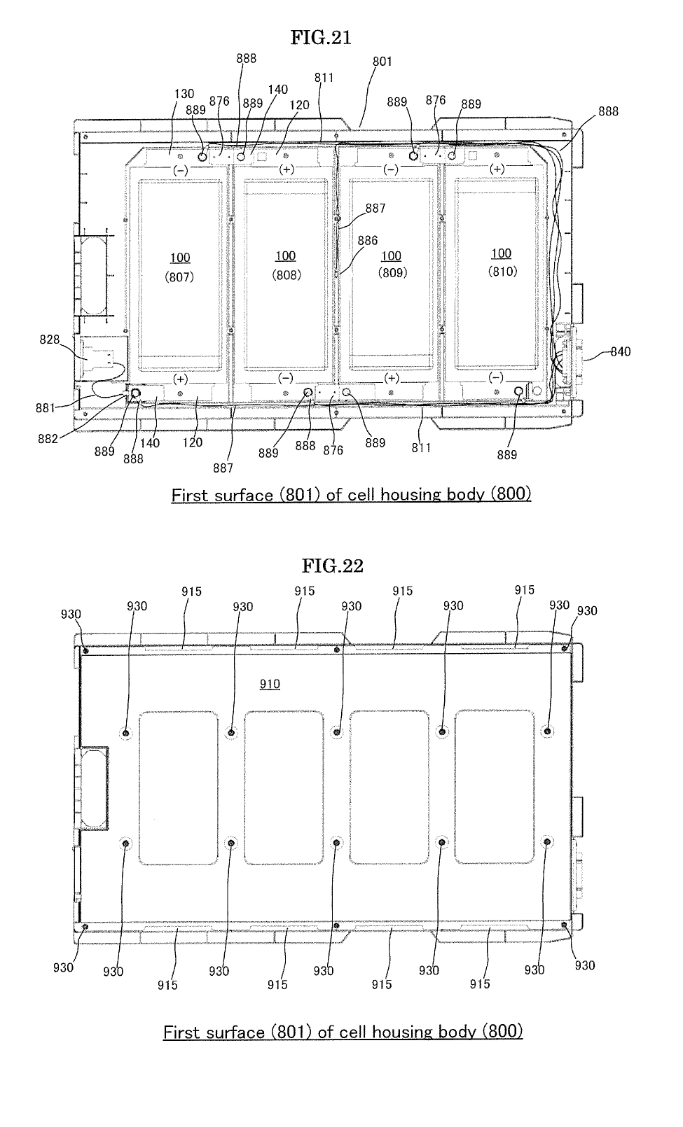

At the next step shown in FIG. 21, in the first cell housing chamber 807, second cell housing chamber 808, third cell housing chamber 809, and fourth cell housing chamber 810 to which the adhesive has been applied, unit cells 100 are placed. At this time, the alignment through-holes 124 of the positive electrode pulled-out tabs 120 of the unit cells 100 and the alignment through-holes 134 of the negative electrode pulled-out tabs 130 are fitted onto the unit cell alignment protruding portions 860 of the unit cell housing body 800. Therefore, the unit cells 100 can be easily positioned, and the production efficiency is therefore excellent. In the diagram, the side where the positive electrode pulled-out tabs 120 of the unit cells 100 are pulled out is marked with (+), and the side where the negative electrode pulled-out tabs 130 are pulled out is marked with (−). As shown in FIG. 21, the polarity of a tab of a unit cell 100 housed in a cell housing chamber is different from the polarity of a tab of a unit cell 100 housed in an adjacent cell housing chamber on one end portion's side of the unit cell housing body 800. Accordingly, when the tabs of the unit cells 100 are electrically connected together via the inter-tab member bus bars 876, the unit cells 100 are connected in series.

According to the present embodiment, in a direction perpendicular to the pullout direction of the pulled-out tabs of the unit cells 100, a plurality of unit cells 100 are arranged in one direction. Furthermore, the tabs of the adjacent unit cells 100 are electrically connected. In this manner, it is easy to have the unit cells 100 connected in series.

With the use of the tab member fixing screw holes 862 and screws 889, the inter-tab member bus bars 876 and the tabs of the unit cells 100 are electrically and mechanically fastened. In this case, one of the two screws 889 that fasten the inter-tab member bus bar 876 also fastens a sense line terminal 888. The sense line terminal 888 is electrically connected to the second connector 840 via a sense line 887 that is laid in the first surface sense line housing portion 811. Therefore, via the second connector 840, potential information of the tabs of the unit cells 100 can be output.

Incidentally, as described above, the holes that are made in the positive electrode pulled-out tabs 120, negative electrode pulled-out tabs 130, and additional tab members 140 of the unit cells 100 are formed based on the reference portions 107 of the laminate film exterior members. Accordingly, when the unit cells 100 are fixed to the unit cell housing body 800 with screws 889, the possibility is low that the unit cells 100 are fixed in such a way as to deform the laminate film exterior members. Even if vibration or shock is applied to the battery module, it is possible to reduce the possibility that a portion of the laminate film exterior member where pulled-out tabs are pulled out would break, or the possibility that a portion where the pulled-out tabs are connected to foil-like current collector tabs inside the exterior members would break. In this manner, the unit cell 100 can be produced.

The additional tab member 140 of the unit cell 100 in the first cell housing chamber 807 is electrically and mechanically fastened to the power line terminal 882, sense line terminal 888 and end portion bus bar 875 with a screw 889 on the end portion bus bar 875. The power line terminal 882 is electrically connected to the first connector 828 via the power line 881. Therefore, via the first connector 828, the positive-polarity output can be taken out as that of the battery module.

Between the two first surface compartmentalization partition wall portions 803 that are located between the second cell housing chamber 808 and the third cell housing chamber 809, a thermistor 886 is provided to monitor the temperature of the battery module 1000. The thermistor 886 is electrically connected to the second connector 840 via a thermistor connection line 885. Therefore, via the second connector 840, temperature information of the battery module 1000 can be output.

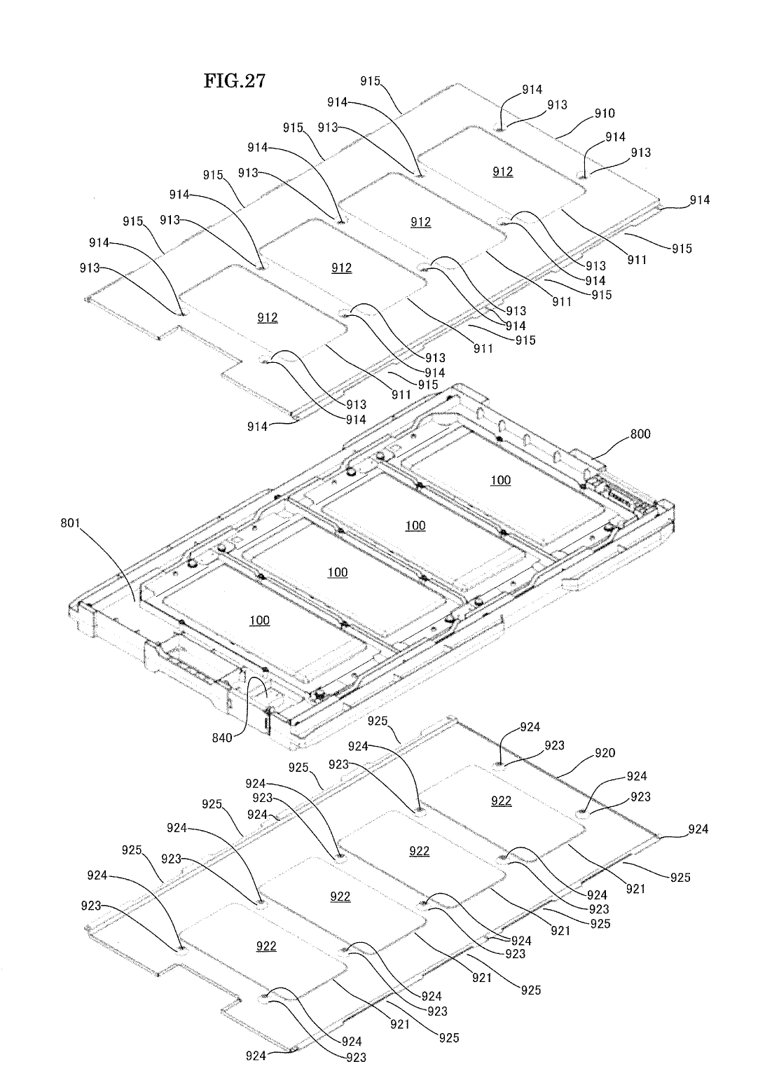

Then, at the step shown in FIG. 22, onto the first surface 801 of the unit cell housing body 800, a first surface cover body 910 is attached with screws 930. With reference to a perspective view of FIG. 27, the first surface cover body 910 will be described. The first surface cover body 910 and a second surface cover body 920 have the same configuration except being in a mirror-symmetrical relation. Therefore, the first surface cover body 910 will be described as an example.

The first surface cover body 910 is an cover member that is made of aluminum, and shields the unit cells 100, power line 881, sense line 887, thermistor 886 and other components housed on the first surface 801 of the unit cell housing body 800.

On the first surface cover body 910, drawing has been performed (Cell pressing drawn portions 911) in order to press the unit cells 100 housed in the cell housing chambers when the first surface cover body 910 is mounted on the first surface 801. The surfaces of the cell pressing drawn portions 911 that press the unit cells 100 are defined as pressing surfaces 912. The pressing surfaces 912 that are based on the cell pressing drawn portions 911 press electrode-stacked regions 105 of the unit cells 100 at a time when the first surface cover body 910 is mounted, thereby keeping the unit cells 100 from bulging even when the unit cells 100 are used over years and extending the life of the unit cells 100.

On the first surface cover body 910, screw holes 914 are formed at positions that correspond to the cover body fixing screw holes 869 when the first surface cover body 910 is attached to the first surface 801. Around the screw holes 914, screw hole drawn portions 913 are provided. Therefore, the first surface cover body 910 is secured in such a way that portions of the first surface cover body 910 that are around the screw holes 914 come in close contact with the first surface 801.

On the first surface cover body 910, cutout portions 915 are provided in such a way as to correspond to the pulled-out tabs of the unit cells 100 at a time when the first surface cover body 910 is mounted on the unit cell housing body 800. The cutout portions 915 ensure the exhaust performance of the battery module 1000.

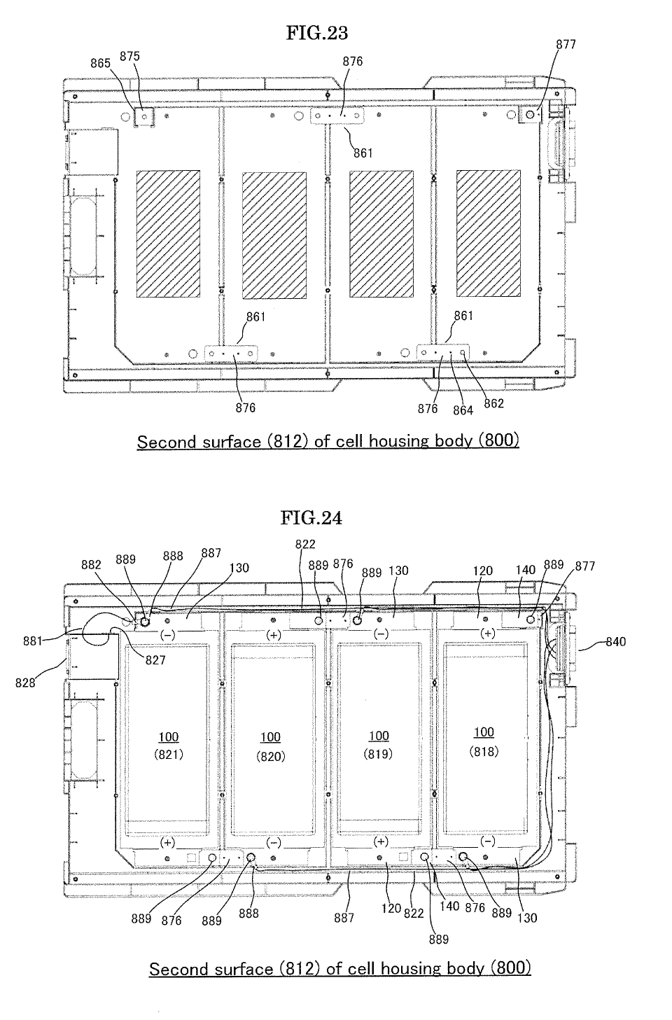

At the next step shown in FIG. 23, on the second surface 812 of the unit cell housing body 800, the through-holes that are provided on the inter-tab member bus bars 876 are fitted onto the bus bar alignment protruding portions 864. In this manner, the inter-tab member bus bars 876 are set on the tab member placement portions 861. On the inter-tab member bus bar 876, a through-hole corresponding to the tab member fixing screw hole 862 is provided in advance. At this step, on the end portion bus bar fixing frame 865, the end portion bus bar 875 is set. In the end portion bus bar 875, a through-hole corresponding to the tab member fixing screw hole 862 is provided in advance. Moreover, an adhesive is applied to the shaded area of each cell housing chamber.

At the next step shown in FIG. 24, on the second surface 812 of the unit cell housing body 800, in the fifth cell housing chamber 818, sixth cell housing chamber 819, seventh cell housing chamber 820, and eighth cell housing chamber 821 to which the adhesive has been applied, unit cells 100 are placed. At this time, the alignment through-holes 124 of the positive electrode pulled-out tabs 120 of the unit cells 100 and the alignment through-holes 134 of the negative electrode pulled-out tabs 130 are fitted onto the unit cell alignment protruding portions 860 of the unit cell housing body 800. Therefore, the unit cells 100 can be easily positioned, and the production efficiency is therefore excellent. In the diagram, the side where the positive electrode pulled-out tabs 120 of the unit cells 100 are pulled out is marked with (+), and the side where the negative electrode pulled-out tabs 130 are pulled out is marked with (−). As shown in FIG. 24, the polarity of a tab of a unit cell 100 housed in a cell housing chamber is different from the polarity of a tab of a unit cell 100 housed in an adjacent cell housing chamber on one end portion's side of the unit cell housing body 800. Accordingly, when the tabs of the unit cells 100 are electrically connected together via the inter-tab member bus bars 876, the unit cells 100 are connected in series.

According to the present embodiment, in a direction perpendicular to the pullout direction of the pulled-out tabs of the unit cells 100, a plurality of unit cells 100 are arranged in one direction. Furthermore, the tabs of the adjacent unit cells 100 are electrically connected. In this manner, it is easy to have the unit cells 100 connected in series.

With the use of the tab member fixing screw holes 862 and screws 889, the inter-tab member bus bars 876 and the tabs of the unit cells 100 are electrically and mechanically fastened. In this case, one of the two screws 889 that fasten the inter-tab member bus bar 876 also fastens a sense line terminal 888. The sense line terminal 888 is electrically connected to the second connector 840 via a sense line 887 that is laid in the first surface sense line housing portion 811. Therefore, via the second connector 840, potential information of the tabs of the unit cells 100 can be output.

The negative electrode pulled-out tab 130 of the unit cell 100 in the eighth cell housing chamber 821 is electrically and mechanically fastened to the power line terminal 882, sense line terminal 888 and end portion bus bar 875 with a screw 889 on the end portion bus bar 875. The power line terminal 882 is electrically connected to the first connector 828 via the power line 881. Therefore, via the first connector 828, the negative-polarity output can be taken out as that of the battery module.

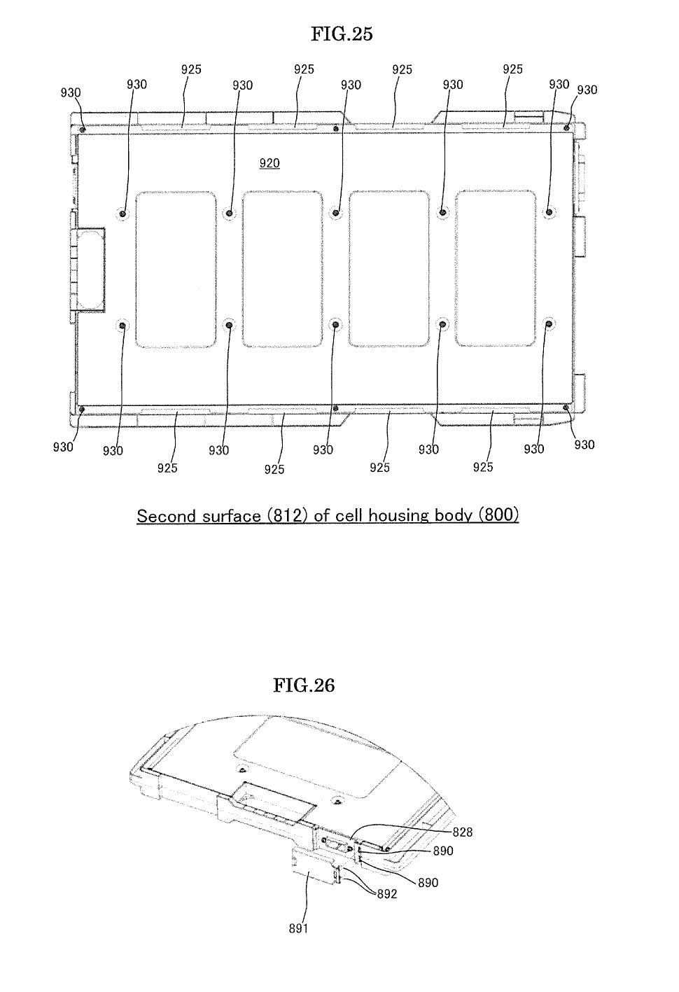

At the next step shown in FIG. 25, on the second surface 812 of the unit cell housing body 800, the second surface cover body 920 is attached with screws 930.

At the next step shown in FIG. 26, a cap member 891 is mounted on the first connector 828. To a conductive terminal of the first connector 828, the combined voltage of the eight unit cells 100 connected in series is being applied. In order to ensure safety in the handling of the battery module 1000, the cap member 891 is used to shield the first connector 828. On the cap member 891, two engagement pieces 892 are provided. Into two engagement openings 890 that are provided on a sidewall portion of the unit cell housing body 800 in such a way as to correspond to the two engagement pieces 892, the two engagement pieces 892 are inserted. Therefore, the cap member 891 can be mounted in such a way as to cover the first connector 828. The cap member 891 will be removed when the battery module 100 is mounted on the power storage device 1200.

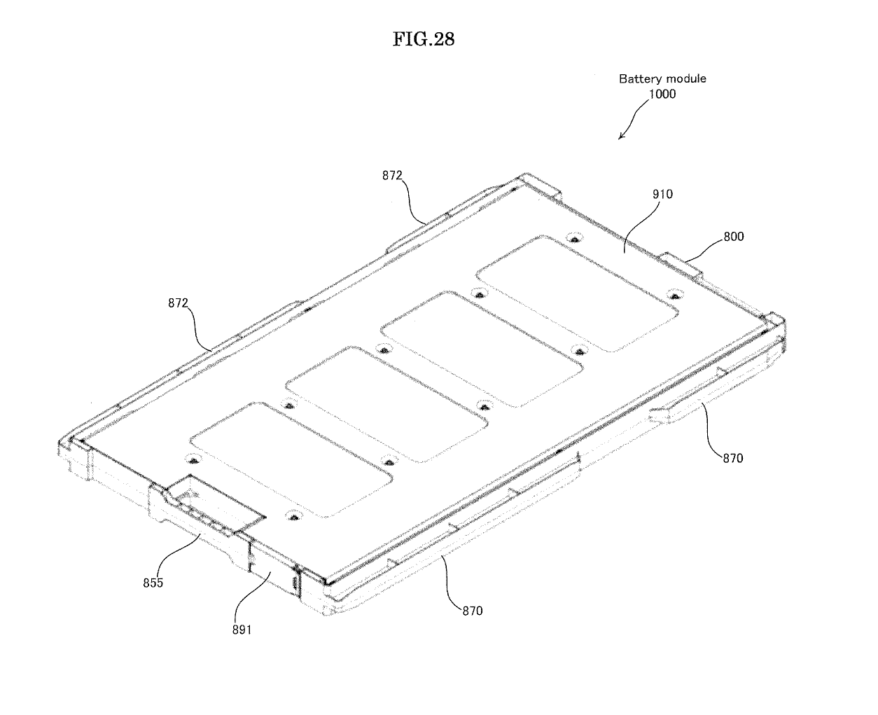

Through the steps described above, the battery module 1000, shown in FIG. 28 that is a perspective view, is completed.

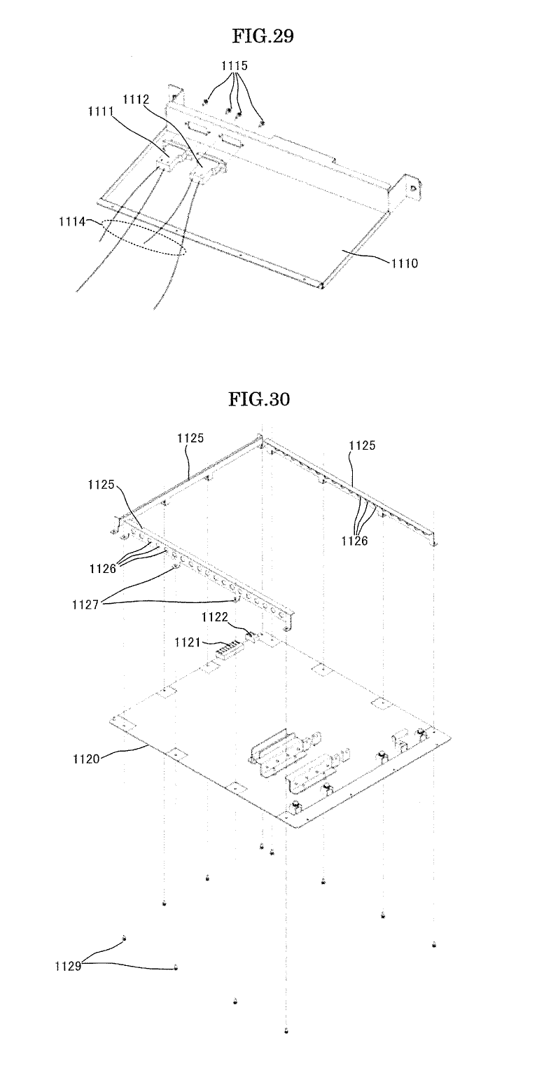

The configuration of the battery management circuit unit 1100, which manages the above-described battery module 1000 of the present invention, will be outlined. FIGS. 29, 30, and 31 are diagrams for explaining the process of producing the battery management circuit unit 1100. FIG. 32 is a diagram showing the battery management circuit unit 1100.

At the step shown in FIG. 29, on a connector panel 1110, a third connector 1111 and a fourth connector 1112 are attached with screws 1115. Given how easily the battery management circuit unit 1100 should be mounted on the power storage device 1200, it is desirable that the battery management circuit unit 1100 be substantially the same in size as the battery module 1000. However, securing that size only with a circuit board 1120 will lead to a cost-related problem. Accordingly, the connector panel 1110 is used.

At the step shown in FIG. 30, on the circuit board 1120 where circuits for managing the battery are mounted, side plates 1125, some of which have ventilation holes 1126 to cool the circuits, are fixed through screws 1129 and screw hole portions 1127 of the circuit board 1120.

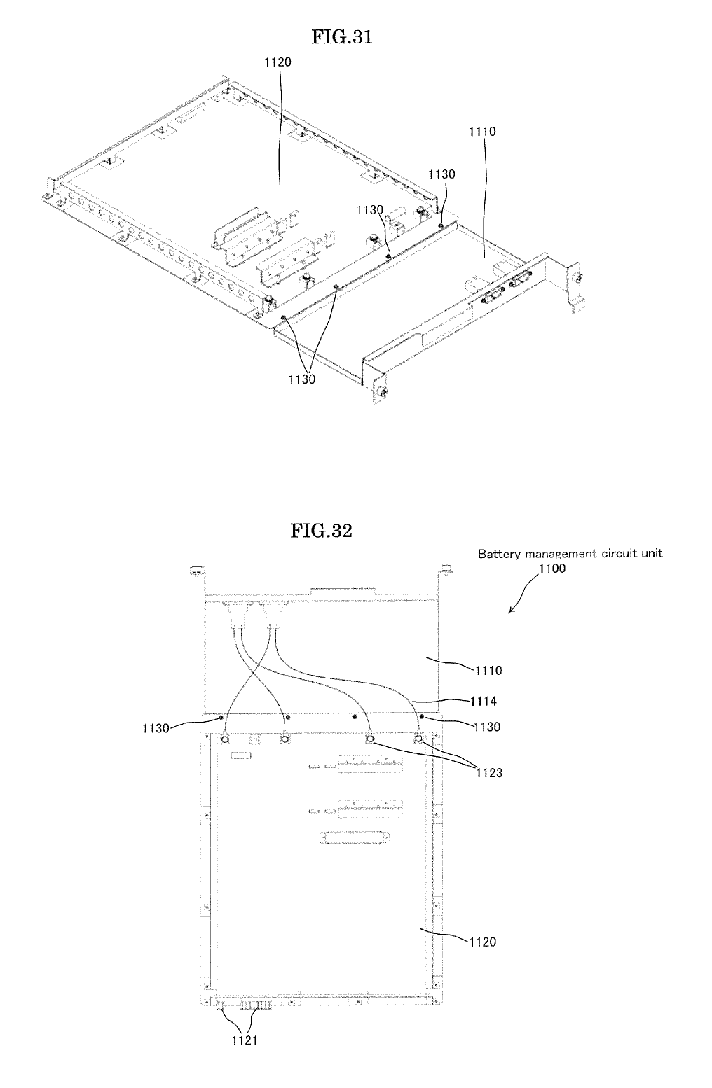

At the step shown in FIG. 31, the circuit board 1120 and the connector panel 1110 are fastened together with screws 1130.

At the step shown in FIG. 32, lead lines 1114 of the third connector 1111 and fourth connector 1112 that are provided on the connector panel 1110 are electrically connected to terminals 1123 of the circuit board 1120.

The battery management circuit unit 1100 having the above configuration includes the third connector 1111, the fourth connector 1112, and the fifth connector 1121.

The power storage device 1200, which includes the above-described battery management circuit unit 1100 and battery module 1000, will be described.

First, the configuration of a rack member 1200, which houses a plurality of battery modules 1000 and the battery management circuit unit 1100, will be described. As for the rack member 1200 of the present embodiment, what will be described is a rack member 1200 that houses 13 battery modules 1000 and a battery management circuit unit 1100, which includes two boards. However, the present invention does not specifically limit the numbers of the battery modules 1000 and battery management circuit units 1100.

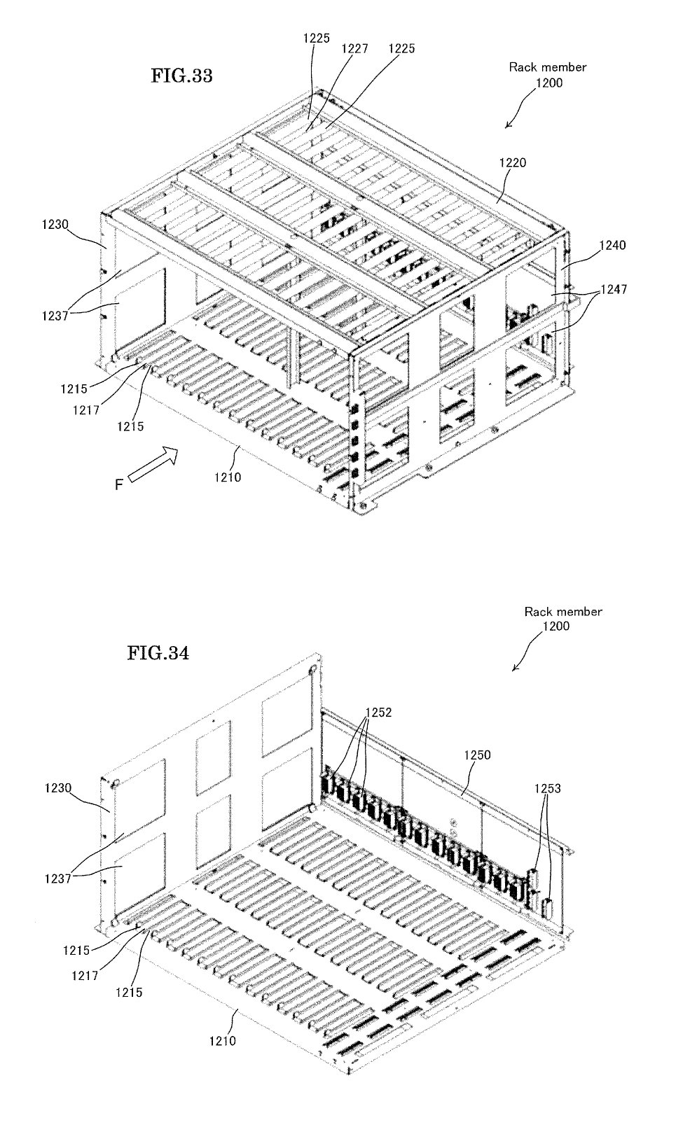

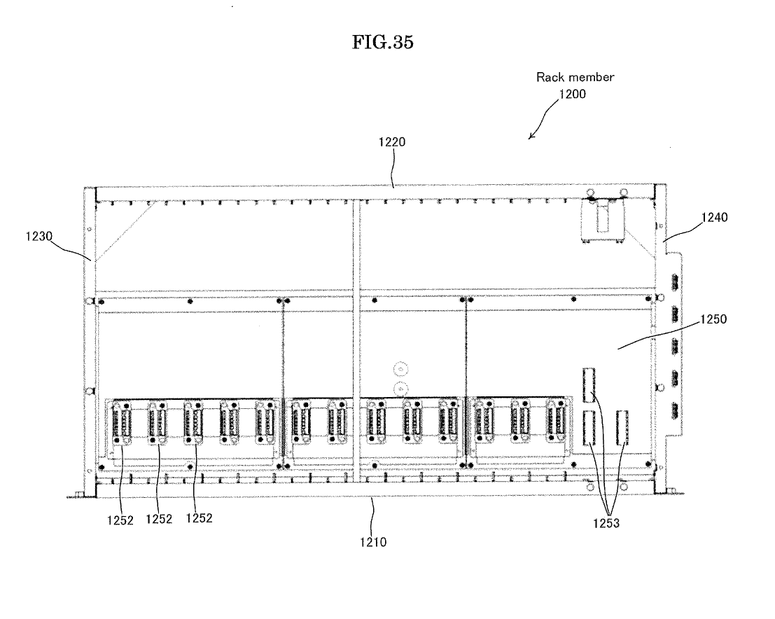

FIG. 33 is a perspective view showing the configuration of the rack member 1200. FIG. 34 is a diagram showing the rack member 1200 from which a top plate 1220 and a second side plate 1240 have been removed. FIG. 35 is a front view of the rack member 1200 when seen from direction F in FIG. 33.

On a bottom plate 1210 that constitutes a bottom portion of the rack member 1200, a plurality of lower guide members 1215 are disposed. On the top plate 1220 that constitutes a ceiling portion of the rack member 1200, a plurality of upper guide members 1225 are disposed.

The lower guide members 1215 and the upper guide members 1225 face each other. When the battery modules 1000 are attached to or detached from the rack member 1200, the lower guide members 1215 and the upper guide members 1225 guide the battery modules 1000.

The guide members are disposed in such a way that, when the battery modules 1000 are mounted on the rack member 1200, a predetermined distance is created between the adjacent battery modules 1000. In this manner, a sufficient space is secured between the adjacent battery modules 1000. Accordingly, it is possible to prevent the heat generated from the battery modules 1000 that make up the power storage device 1300 from staying in the device.

Furthermore, ventilation opening portions 1217 are provided on the bottom plate 1210, and ventilation opening portions 1227 are provided on the top plate 1220. Therefore, it is possible to prevent the flow of air between the adjacent battery modules 1000 from being stopped and thereby to curb an increase in the temperature inside the power storage device 1300.

Between the bottom plate 1210 and the top plate 1220, a first side plate 1230 and a second side plate 1240 are provided in such a way as to face each other and support the top plate 1220 from both sides.

On the first side plate 1230 and the second side plate 1240, ventilation opening portions 1237 are provided on the first side plate 1230, and ventilation opening portions 1247 are provided on the second side plate 1240. This configuration helps the heat released from the battery modules 1000 and battery management circuit unit 1100 to escape from the power storage device 1300.

Incidentally, as for the power storage device 1300 of the present invention, the power storage devices 1300 might be used after being stacked in the vertical direction. Therefore, providing the above-described ventilation opening portions to keep the temperatures inside the power storage devices 1300 from rising is very important.

Between the first side plate 1230 and the second side plate 1240, a rear plate 1250 that has a plurality of connectors is provided.

On the rear plate 1250, seventh connectors 1252, to which the second connectors 840 of the battery modules 1000 are fitted, and eighth connectors 1253, to which the fifth connectors 1121 of the battery management circuit units 1100 are fitted, are provided. Wires, not shown, are laid to relay sense information and temperature information of each battery module 1000 to the battery management circuit units 1100. The battery management circuit units 1100 therefore acquire potential data of each unit cell 100 and data of temperatures in each battery module 1000, and conducts such control as the stopping of discharge based on the data.

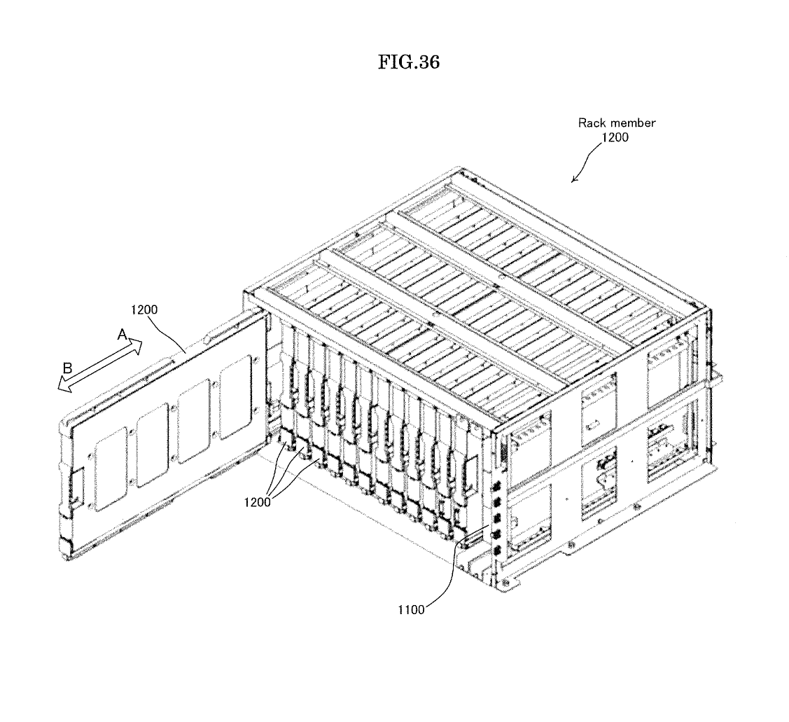

FIG. 36 shows how a battery module 1000 is sliding and being set into the rack member 1200 of the power storage device 1300 with the help of the guide members. As shown in FIG. 36, when the battery module 1000 slides toward side A, the battery module 1000 can be mounted on the rack member 1200. When the battery module 1000 slides toward side B, the battery module 1000 can be removed from the rack member 1200. Therefore, in the power storage device 1300 of the present invention, the battery modules 1000 can be easily replaced.

When the battery module 1000 slides toward side A and is mounted on the rack member 1200, the second connector 840 of the battery module 1000 needs to be fitted to the seventh connector 1252 of the rear plate 1250, which is the rear side of the rack member 1200.

If there is tolerance on the guide members and the like, it is difficult to fit the second connector 840 to the seventh connector 1252. Accordingly, the second connector 840 is configured in such a way as to slightly move to cover the above tolerance.

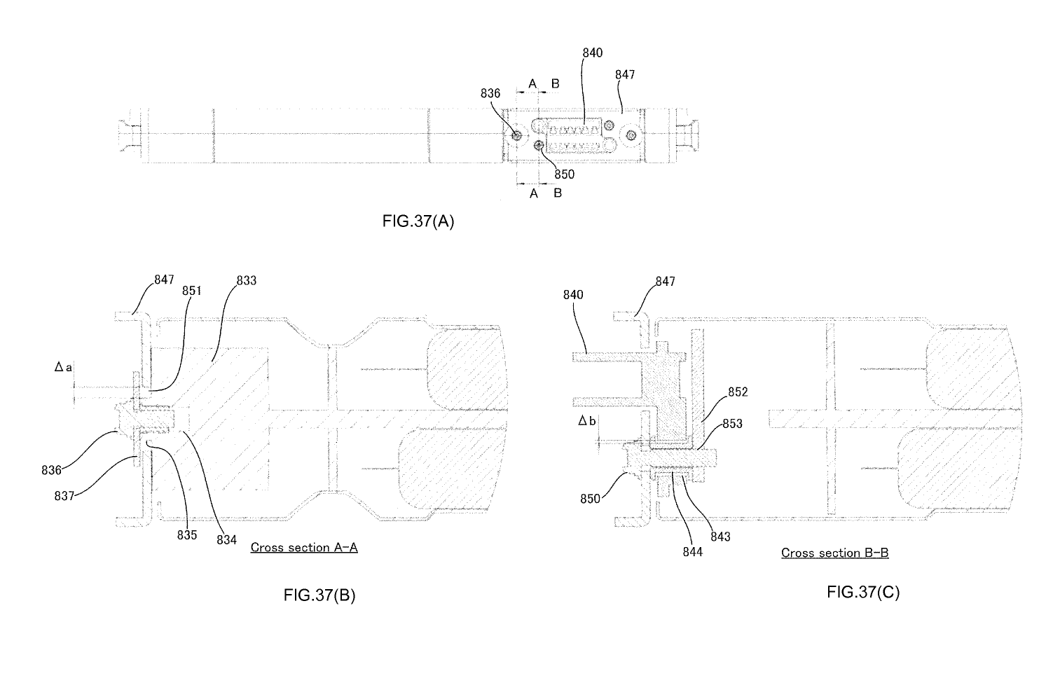

The configuration that enables the second connector 840 to move as described above will be described. FIG. 37 is a diagram for explaining how an area around the second connector 840 of the battery module 1000 is formed. FIG. 37A is a front view of the second connector 840 of the battery module 1000. FIG. 37B is a cross-sectional view of FIG. 37A taken along A-A. FIG. 37C is a cross-sectional view of FIG. 37A taken along B-B.

As shown in FIG. 37B, on the panel mounting base portion 833 of the unit cell housing body 800, a screw hole peripheral protruding portion 835 is provided in such a way as to protrude from a plane formed by the panel mounting base portion 833. At the center of the screw hole peripheral protruding portion 835, a panel mounting screw hole 834 is provided to be used for mounting of the connector mounting panel 847 onto the unit cell housing body 800.

The outer diameter of the screw hole peripheral protruding portions 835 that will be inserted into the mounting cutout portions 851 which are provided on both sides of the connector mounting panel 847 is smaller than the inner side portions of the mounting cutout portions 851 by 2Δa, as shown in the diagram. Therefore, the connector mounting panel 847 can move within the range of 2Δa with respect to the unit cell housing body 800.

As shown in FIG. 37C, a bush 844 is mounted in a through-hole 843 of the second connector 840. The outer diameter of the bush 844 is smaller than the inner diameter of the through-hole 843 by 2Δb. Therefore, a body portion 841 of the second connector 840 can move within the range of 2Δb with respect to the bush 844.

The connector mounting panel 847 can move within the range of 2Δa with respect to the unit cell housing body 800. Furthermore, the second connector 840 can move within the range of 2Δb with respect to the connector mounting panel 847. Therefore, the second connector 840 can move within the range of 2Δa+2Δb with respect to the unit cell housing body 800.

Dimensional relation Δa>Δb is preferably set. The second connector 840 of the battery module 100 that is being guided while the position thereof is restricted by the rail member is roughly positioned with respect to the seventh connector 1252 because of a tolerance of 2Δa. Furthermore, because of a tolerance of 2Δb, at the timing when the second connector 840 is fitted to the seventh connector 1252, the second connector 840 is fitted to the seventh connector 1252. If dimensional relation Δa>Δb is set, the second connector 840 is more smoothly fitted to the seventh connector 1252 as described above.

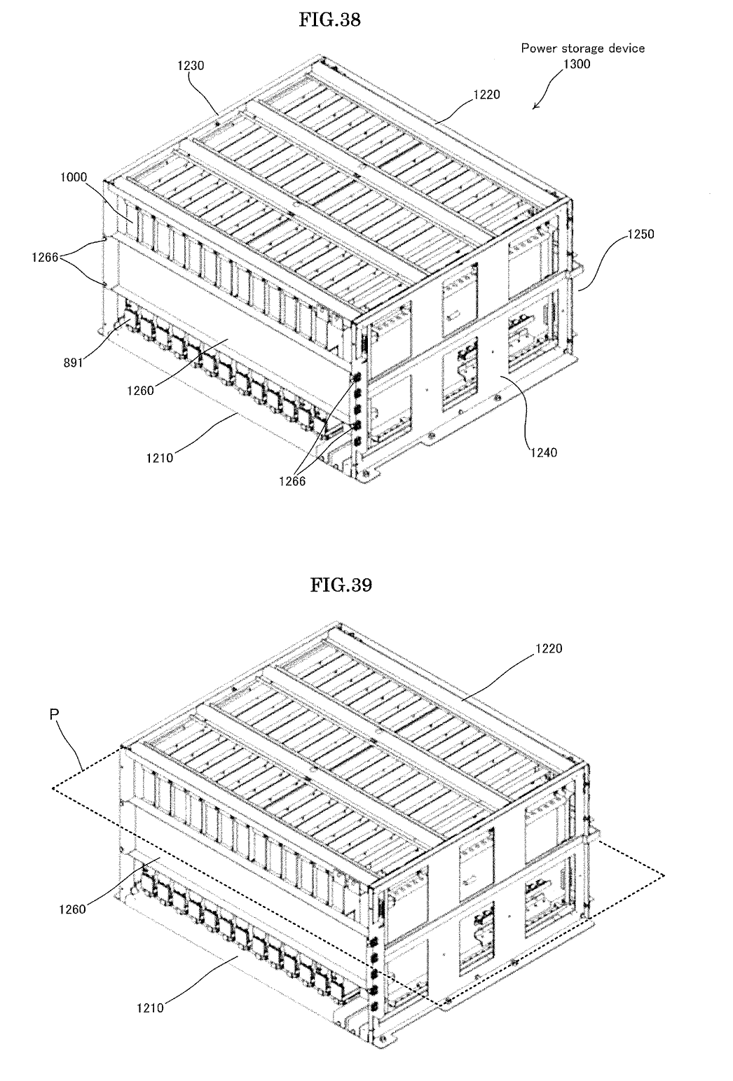

FIG. 38 shows the situation where a holding plate 1260 is fixed to the rack member 1200, or the situation where the power storage device 1300 of the embodiment of the present invention has been completed.

Incidentally, although not shown in FIG. 38, the cap member 891 of each battery module 1000 is removed, and the battery modules 1000 are connected in series via power lines, which are not shown in the diagram. The power lines of both ends that are connected in series are input into a third connector 1111 of a battery management circuit unit 1100. The power storage device 1300 is completed by setting the battery modules 1000 and the battery management circuit unit 1100 as described above.

The holding plate 1260, which is made of stainless steel, is fixed to the first side plate 1230 and second side plate 1240 with bolts and nuts 1266. In this manner, the holding plate 1260 continues pressing the battery modules 1000 in a direction in which the seventh connectors 1252 of the rear plate 1250 is fitted to the second connectors 840 of the battery modules 1000. In this manner, the holding plate 1260 acts in such a way as to press the battery modules 1000. Therefore, the vibration and shock resistance of the power storage device 1300 can be ensured.

It is preferred that the holding plate 1260 be designed in such a way as not to touch both the bottom plate 1210 and top plate 1220. The reason is because the space between the bottom plate 1210 and the holding plate 1260 and the space between the top plate 1220 and the holding plate 1260 will be openings that do not block the flow of air, thereby curbing a rise in the temperatures of the battery modules 1000 and battery management circuit unit 1100.

The holding plate 1260 is preferably disposed in such a way that a middle virtual plane P of the bottom plate 1210 and top plate 1220 crosses the holding plate 1260. FIG. 39 is a diagram showing such a virtual plane P as indicated by dotted line. If the holding plate 1260 is disposed as described above, the center of gravity of the battery modules 1000 when viewed in the vertical direction is supported by the holding plate 1260. Therefore, it is possible to efficiently give the power storage device 1300 vibration and shock resistance.

In the power storage device 1300 of the present invention, the battery modules 1000 are guided by the guide members when attached or detached. Furthermore, the wires are connected via the connectors. Furthermore, the holding plate 1260 is provided in such a way as to press the battery modules 1000 in the direction in which the connectors of the rear plate 1250 are fitted to the connectors of the battery modules 1000. Therefore, in the power storage device 1300 of the present invention, the battery modules 1000 can be easily replaced, and the vibration and shock resistance of the power storage device can be ensured.

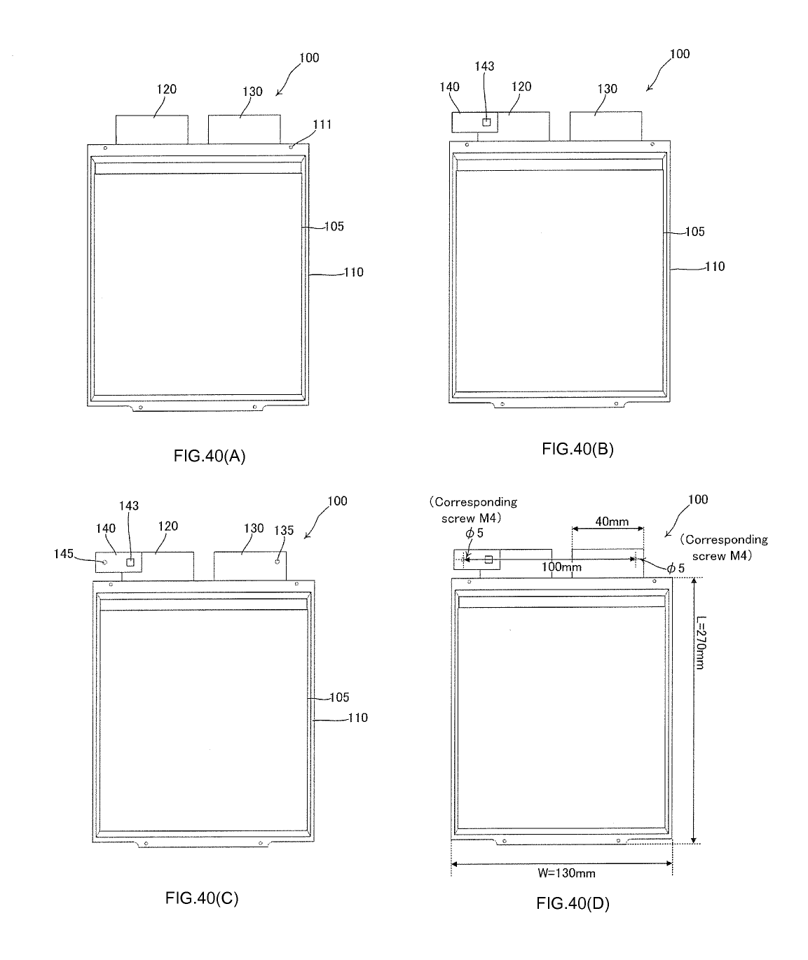

Another embodiment of the present invention will be described. FIG. 40 is a diagram showing a unit cell 100 used in a second embodiment and preliminary processing steps thereof. FIG. 40 corresponds to FIG. 1, which shows the unit cell 100 used in the above-described first embodiment. FIGS. 40A to 40D correspond to FIGS. 1A and 1D. The components represented by the same reference symbols as those in FIG. 40 are identical, and therefore will not be described.

The unit cell 100 of the present embodiment is different from the unit cell 100 of the first embodiment in that the positive electrode pulled-out tab 120 and the negative electrode pulled-out tab 130 are pulled out from the same side of the laminate film exterior members.

FIG. 40D is a diagram for explaining the dimensions of the unit cell 100 of the second embodiment that has been preliminarily processed, and the like. The dimensions and other factors of the unit cell 100 are as follows:
Dimensions of unit cell 100 (except for pulled-out tabs): L270 mm, W230 mm
Width of pulled-out tabs: 40 mm
Through-hole 145 of positive electrode-side additional tab member 140: φ5
Through hole 135 of negative electrode pulled-out tab 130: φ5
Distance between through-holes 145 and 135: 100 mm
Screws 889 for through-holes 145 and 135: M4
Weight of unit cell 100: 800 g

Furthermore, as a unit cell 100 of a third embodiment in which the positive electrode pulled-out tab 120 and the negative electrode pulled-out tab 130 are pulled out from the same side of the laminate film exterior members, the one having the following dimensional relations and the like were prepared:
Dimensions of unit cell 100 (except for pulled-out tabs): L150 mm, W80 mm
Width of pulled-out tabs: 12 mm
Through-hole 145 of positive electrode-side additional tab member 140: φ4
Through hole 135 of negative electrode pulled-out tab 130: φ4
Distance between through-holes 145 and 135: 30 mm
Screws 889 for through-holes 145 and 135: M3
Weight of unit cell 100: 150 g

Moreover, unit cells 100 of Comparative Examples 1 to 3, which are equal in size to the unit cells 100 of the above first to third embodiment, were prepared. In the case of the unit cells 100 of Comparative Examples 1 to 3, when the unit cells 100 were produced, a production method by which holes were made in advance in the positive electrode pulled-out tabs 120, negative electrode pulled-out tabs 130, additional tab members 140, and other components was employed.

The unit cells 100 of the first to third embodiments, and the unit cells 100 of Comparative Examples 1 to 3 were bonded to the unit cell housing bodies 800. In particular, when the unit cells 100 of Comparative Example 1 were bonded to the unit cell housing bodies 800, some of them were found fixed in such a way as to deform the laminate film exterior members.

As described above, it was found that the method of present invention by which holes are provided in the positive electrode pulled-out tabs 120, negative electrode pulled-out tabs 130, additional tab members 140, and other components based on the reference portions 107 of the laminate film exterior members becomes more effective as the battery becomes bigger. In particular, the distance between the holes used for fixing the unit cells 100 is preferably 30 mm or more. Incidentally, there is no upper limit on the distance between the holes. However, if productivity or any other factor is taken into consideration, the distance between the holes should be set at 1,000 mm or less.

The present invention is highly effective if the unit cell 100 weighs 800 g or more. There is no upper limit on the weight of the unit cell 100. However, if productivity or any other factor is taken into consideration, the weight should be set in such a way as not to exceed 2,000 g.

As for the screws 889 that are screwed into the holes of the positive electrode pulled-out tabs 120, negative electrode pulled-out tabs 130, and additional tab members 140, the diameter of the holes is preferably 1 to 1.5 times the diameter of the screws 889.

As described above, according to the battery production method of the present invention, based on the reference portions of the exterior members, the holes used for fixation are bored in the positive electrode pulled-out tab and negative electrode pulled-out tab. Therefore, according to the battery production method of the present invention, when the unit cells are fixed to the housing body of the battery module or the like, the possibility is low that the unit cells are fixed in such a way as to deform the exterior members. Even if vibration or shock is applied to the battery module, it is possible to reduce the possibility that a portion of the exterior member where pulled-out tabs are pulled out would break, or the possibility that a portion where the pulled-out tabs are connected to foil-like current collector tabs inside the exterior members would break. In this manner, the cells can be produced.

In the battery module of the present invention, the first distance between the reference portion of the exterior members and the position of the hole formed in the positive electrode pulled-out tab, and the second distance between the reference portion of the exterior members and the position of the hole formed in the negative electrode pulled-out tab are equal among all the unit cells housed in the housing body. Therefore, in the battery module of the present invention, the possibility is low that the deformed exterior members would be fixed to the housing body of the battery module or the like. Even if vibration or shock is applied to the battery module, it is possible to reduce the possibility that a portion of the exterior member of the unit cell where pulled-out tabs are pulled out would break, or the possibility that a portion where the pulled-out tabs are connected to foil-like current collector tabs inside the exterior members would break.

### EXPLANATION OF REFERENCE SYMBOLS

20: Positive electrode
23: Positive electrode substrate
24: Positive electrode current collector tab
26: Positive electrode material mixture application portion
28: Positive electrode-side connection portion
30: Negative electrode
33: Negative electrode substrate
34: Negative electrode current collector tab
36: Negative electrode material mixture application portion
38: Negative electrode-side connection portion
40: Separator
50: Battery element
61: First laminate film exterior member
62: Second laminate film exterior member
80: Jig
81: Base
82: Alignment reference angle portion
84: Positive electrode seat
85: Negative electrode seat
100: Unit cell
105: Electrode-stacked region
107: Reference portion
110: Cell body portion
120: Positive electrode pulled-out tab
124: Alignment through-hole
130: Negative electrode pulled-out tab
134: Alignment through-hole
135: Through-hole
140: Additional tab member
143: Welding portion
145: Through-hole
150: Double-sided tape
800: Unit cell housing body
801: First surface
802: First surface peripheral partition wall portion
803: First surface compartmentalization partition wall portion
804: Compartmentalization partition wall cutout portion
805: First surface intermediate partition wall portion
806: Intermediate partition wall cutout portion
807: First cell housing chamber
808: Second cell housing chamber
809: Third cell housing chamber
810: Fourth cell housing chamber
811: First surface sense line housing portion
812: Second surface
813: Second surface peripheral partition wall portion
814: Second surface compartmentalization partition wall portion
815: Compartmentalization partition wall cutout portion
816: Second surface intermediate partition wall portion
817: Intermediate partition wall cutout portion
818: Fifth cell housing chamber
819: Sixth cell housing chamber
820: Seventh cell housing chamber
821: Eighth cell housing chamber
822: Second surface sense line housing portion
824: First connector housing concave portion
825: First connector mounting opening portion
826: First connector mounting screw hole
827: Power line opening portion
828: First connector
829: Mounting screw
832: Second connector mounting concave portion
833: Panel mounting base portion
834: Panel mounting screw hole
835: Screw hole peripheral protruding portion
836: Mounting screw
837: Retaining washer
840: Second connector
841: Body portion
842: Metal terminal portion
843: Through-hole
844: Bush
847: Connector mounting panel
848: Connector mounting opening portion
849: Connector mounting screw hole
850: Mounting screw
851: Mounting cutout portion
852: Fastening member
853: Female screw hole
854: Handle through-hole
855: Handle portion
860: Unit cell alignment protruding portion
861: Tab member placement portion
862: Tab member fixing screw hole
863: Inter-screw hole bridge portion
864: Bus bar alignment protruding portion
865: End portion bus bar fixing frame
867: Bus bar guidance through-hole
869: Cover body fixing screw hole
870: First end side protruding guide member
871: Tapered portion
872: Second end side protruding guide member
873: Tapered portion
875: End portion bus bar
876: Inter-tab member bus bar
877: Surface-to-surface bus bar
881: Power line
882: Power line terminal
883: Screw
885: Thermistor connection line
886: Thermistor
887: Sense line
888: Sense line terminal
889: Screw
890: Engagement opening
891: Cap member
892: Engagement piece
910: First surface cover body
911: Cell pressing drawn portion
912: Pressing surface
913: Screw hole drawn portion
914: Screw hole
915: Cutout portion
920: Second surface cover body
921: Cell pressing drawn portion
922: Pressing surface
923: Screw hole drawn portion
924: Screw hole
925: Cutout portion
930: Screw
1000: Battery module
1100: Battery management circuit unit
1110: Connector panel
1111: Third connector
1112: Fourth connector
1114: Lead line
1115: Screw
1120: Circuit board
1121: Fifth connector
1123: Terminal
1125: Side plate
1126: Ventilation hole
1127: Screw hole portion
1129: Screw
1130: Screw
1152: Seventh connector
1153: Eighth connector
1200: Rack member
1210: Bottom plate
1215: Lower guide member
1217: Ventilation opening portion
1220: Top plate
1225: Upper guide member
1227: Ventilation opening portion
1230: First side plate
1237: Ventilation opening portion
1240: Second side plate
1247: Ventilation opening portion
1250: Rear plate
1252: Seventh connector
1253: Eighth connector
1260: Pressing plate
1266: Bolt and nut
1300: Power storage device
P: Virtual plane

1-23. (canceled)

24. A battery production method comprising:
preparing a battery element in which a positive electrode that includes a positive electrode current collector tab, and a negative electrode that includes a negative electrode current collector tab are stacked or wound through a separator;
connecting a positive electrode pulled-out tab to the positive electrode current collector tab and connecting a negative electrode pulled-out tab to the negative electrode current collector tab;
enclosing the battery element, positive electrode current collector tab and negative electrode current collector tab in a flexible exterior member, with the positive electrode pulled-out tab and negative electrode pulled-out tab being pulled out;
forming a reference portion on the exterior member; and
boring, in the positive electrode pulled-out tab and negative electrode pulled-out tab being pulled out of the exterior member, holes that are to be used for fixation, based on the reference portion after said forming.

25. The battery production method according to claim 24, wherein
a distance between a hole formed in the positive electrode pulled-out tab and a hole formed in the negative electrode pulled-out tab has been determined.

26. The battery production method according to claim 24, wherein
the exterior member is made of laminate film.

27. The battery production method according to claim 24, wherein
the holes are formed with reference to a portion of periphery of the exterior member.

28. The battery production method according to claim 24, wherein
a distance between a hole formed in the positive electrode pulled-out tab and a hole formed in the negative electrode pulled-out tab is 30 mm or more.

29. The battery production method according to claim 24, wherein
the battery weighs 800 g or more.

30. The battery production method according to claim 24, wherein
fastening members are inserted into the holes, and the diameter of the holes is 1 to 1.5 times the diameter of the fastening members.

31. The battery production method according to claim 24, wherein
during said boring, holes are simultaneously formed in the positive electrode pulled-out tab and negative electrode pulled-out tab.

32. The battery production method according to claim 24, wherein
two or more of the batteries are housed in a housing body.

33. A battery production method comprising:
preparing a battery element in which a positive electrode that includes a positive electrode current collector tab, and a negative electrode that includes a negative electrode current collector tab are stacked or wound through a separator;
connecting a positive electrode pulled-out tab to the positive electrode current collector tab and connecting a negative electrode pulled-out tab to the negative electrode current collector tab;
enclosing the battery element, positive electrode current collector tab and negative electrode current collector tab in a flexible exterior member, with the positive electrode pulled-out tab and negative electrode pulled-out tab being pulled out;
forming a reference portion on the exterior member;
connecting an additional tab member to the positive electrode pulled-out tab or negative electrode pulled-out tab; and
boring, in the positive electrode pulled-out tab, negative electrode pulled-out tab and additional tab member being pulled out of the exterior member, holes that are to be used for fixation, based on the reference portion after said connecting.

34. The battery production method according to claim 33, wherein
distances between a hole formed in the positive electrode pulled-out tab, a hole formed in the negative electrode pulled-out tab, and a hole formed in the additional tab member have been determined.

35. The battery production method according to claim 33, wherein
the exterior member is made of laminate film.

36. The battery production method according to claim 33, wherein
the holes are formed with reference to a portion of periphery of the exterior member.

37. The battery production method according to claim 33, wherein
a distance between a hole formed in the positive electrode pulled-out tab and a hole formed in the negative electrode pulled-out tab is 30 mm or more.

38. The battery production method according to claim 33, wherein
the battery weighs 800 g or more.

39. The battery production method according to claim 33, wherein
fastening members are inserted into the holes, and the diameter of the holes is 1 to 1.5 times the diameter of the fastening members.

40. The battery production method according to claim 33, wherein
during said boring, holes are simultaneously formed in the positive electrode pulled-out tab, negative electrode pulled-out tab, and additional tab member.

41. The battery production method according to claim 33, wherein
two or more of the batteries are housed in a housing body.

42. A battery module that houses two or more unit cells in a housing body, wherein:
the unit cells each include
a flexible exterior member that includes a reference portion on a periphery thereof, and
a positive electrode pulled-out tab and negative electrode pulled-out tab that are pulled out of the exterior member and where holes are formed; and
a first distance between the reference portion and position of a hole formed in the positive electrode pulled-out tab and a second distance between the reference portion and position of a hole formed in the negative electrode pulled-out tab are equal among all the unit cells housed in the housing body.

43. The battery module according to claim 42, wherein:
an additional tab member is connected to at least the positive electrode pulled-out tab or the negative electrode pulled-out tab, and a hole is formed in the additional tab member; and
a third distance between the reference portion and position of a hole formed in the additional tab member is equal among all the unit cells housed in the housing body.

44. The battery module according to claim 42, wherein
a distance between a hole formed in the positive electrode pulled-out tab and a hole formed in the negative electrode pulled-out tab is 30 mm or more.

45. The battery module according to claim 42, wherein
the unit cell weighs 800 g or more.

46. The battery module according to claim 42, wherein
fastening members are inserted into the holes, and the diameter of the holes is 1 to 1.5 times the diameter of the fastening members.
